(19) United States
(12) Patent Application Publication
(10) Pub. No.: US 2025/0372607 A1
(43) Pub. Date: Dec. 4, 2025

(54) METHODS OF PRE-LITHIATING ELECTRODES FOR LITHIUM-ION BATTERIES, AND LITHIUM-ION BATTERIES OBTAINED THEREFROM

(71) Applicant: Tyfast, San Diego, CA (US)

(72) Inventors: Haodong LIU, San Diego, CA (US); Ping LIU, San Diego, CA (US); Gerardo Jose LA O', San Mateo, CA (US); Min WEI, San Diego, CA (US); Kangwoon KIM, San Diego, CA (US); Shijie FENG, San Diego, CA (US)

(21) Appl. No.: 19/222,921

(22) Filed: May 29, 2025

Related U.S. Application Data
(60) Provisional application No. 63/654,402, filed on May 31, 2024.
(60) Provisional application No. 63/740,644, filed on Dec. 31, 2024.

(51) Int. Cl. H01M 4/04; H01M 4/02; H01M 4/38; H01M 4/42; H01M 4/46; H01M 4/485; H01M 4/505; H01M 4/525; H01M 4/58; H01M 4/587; H01M 4/60; H01M 10/0525

(52) U.S. Cl. CPC H01M 4/0459; H01M 4/0471; H01M 4/386; H01M 4/42; H01M 4/463; H01M 4/466; H01M 4/485; H01M 4/505; H01M 4/525; H01M 4/5815; H01M 4/582; H01M 4/5825; H01M 4/587; H01M 4/604; H01M 10/0525; H01M 2004/027; H01M 2004/028

(57) ABSTRACT

Existing pre-lithiation methods are beset by many limitations, such as non-uniformity, over-lithiation, poor compatibility with battery components, and scaling challenges. This disclosure provides several technical solutions to the problem of effectively pre-lithiating electrodes. Some variations provide an electrochemical method of pre-lithiating a lithium-ion battery containing lithium vanadium oxide. Porous electrodes ameliorate the V₂O₅ pre-lithiation procedure, enhancing overall efficiency. Various configurations are disclosed, employing two or three electrodes. Other methods pre-lithiate any electrode material for a lithium-ion battery, utilizing a liquid lithium-ion conductor in a transport path with an electrode precursor powder material, to react lithium with the electrode precursor material, thereby generating a pre-lithiated electrode. Still other methods pre-lithiate any electrode material for a lithium-ion battery, mechanically agitating an electrode precursor material with a solid lithium-containing material, to react lithium with the electrode precursor material, thereby generating a pre-lithiated electrode. Experimental data are presented to demonstrate the technology.

### PRIORITY DATA

This international patent application claims priority to U.S. Provisional Patent App No. 63/654,402, filed on May 31, 2024, and to U.S. Provisional Patent App No. 63/740,644, filed on Dec. 31, 2024, each of which is hereby incorporated by reference.

### STATEMENT REGARDING FEDERALLY SPONSORED RESEARCH OR DEVELOPMENT

This invention was made with Government support under Contract No. DE-AR0001732, with ARPA-E within the U.S. Department of Energy. The U.S. Government has certain rights in this invention.

### FIELD

The present disclosure generally relates to lithium-ion batteries containing electrodes incorporating lithiated compounds, and methods for pre-lithiating such batteries.

### BACKGROUND

The push to electrify transportation will require the United States electric grid to double in capacity by 2050, assuming 186 million (two-thirds) of light-duty vehicles are converted to electrical energy rather than combustion engines. This shift will necessitate massive investments in new transmission lines and distribution systems that could reach over $1 trillion by 2050 when all 186 million light-duty electric vehicles (EVs) are in service. The distribution system—the last mile in electricity delivery, including substations, circuits, switches, and transformers, that connects to the EV charging station—will incur over 90% of this projected investment. Optimized EV charging and vehicle-to-grid integration can reduce the required distribution investments by ˜70% or $600 billion by minimizing congestion at the distribution level, allowing two-way energy transfers, storing energy closer to the load, and integrating widely distributed renewables.

Rechargeable lithium-ion (Li-ion) batteries that can be safely charged and discharged at high rates are desirable for electrified transportation, portable electronics, grid storage, and other important applications. Rechargeable Li-ion batteries have made mobile devices and personal computers an essential necessity in modern society. While important advancements in battery technology (e.g., energy density and structural stability) have continued, fast charging is a challenge that still requires significant advances for Li-ion batteries. Li-ion batteries may possess high energy density; however, the rate at which the battery can charge is limited by the battery anode.

Graphite has so far been the dominant anode material for rechargeable lithium-ion batteries due to its low cost, high reversibility, and working potential close to lithium metal. These attributes have led to batteries with high specific energy and long cycle life. The current commercial high-energy-density Li-ion batteries based on graphite anodes achieve a high energy density greater than 250 W·h/kg. However, these Li-ion batteries require several hours to charge. This is a significant problem, as can be attested by anyone with an electric vehicle held up at a charging station for hours-causing a tremendous waste of precious time.

Demand for ultrafast charging poses significant challenges for graphite. Under high charging rates, the anode potential in graphite can be driven to a value that causes lithium plating. Such lithium deposition leads to losses in battery lifetime and higher safety risk. Decreasing the battery charging time to minutes sacrifices energy and severely reduces cycle life for Li-ion batteries using graphite anodes.

The state-of-the-art commercially available anode for ultra-fast-charge Li-ion batteries is lithium titanate, Li₄Ti₅O₁₂ (LTO). Li₄Ti₅O₁₂ is a generally safe material that can charge in less than 10 minutes for many cycles, but its energy density is less than 90 W·h/kg. Li₄Ti₅O₁₂ has a potential of about 1.5 V vs. Li/Li⁺, which leads to a 2.5 V Li-ion battery when paired with a commercial 4 V cathode. The low energy density has limited the application of LTO primarily to buses and utility vehicles. The potentials for other intercalation anodes, such as LiV_{0.5} Ti_{0.5}S₂, are around 1 V, still far higher than desired. Alloy anodes (e.g., anodes using aluminum alloys) can have ideal potentials of 0.5 V and large capacities, but their cycling stabilities remain questionable even under normal operating conditions-let alone for extremely fast charging. None of the state-of-the-art systems can achieve both high energy density combined with high power density, thus defining a technology gap.

A severe challenge to widespread vehicle-to-grid adoption is the degradation of the battery as a result of high wear from extensive usage of the battery, in frequent discharging (while driving the EV) and charging (while connected to the grid for recharging). Similar challenges exist for heavy-duty vehicles, construction vehicles,, two-wheel vehicles, boats, robotics, drones, electric vertical take-off and landing aircraft, and many other applications.

There remains a need for improved lithium-ion batteries. What is especially desired is a safe Li-ion battery that has at least 100 W·h/kg energy density. Convenient methods of pre-lithiating the lithium-ion battery are sought as well.

### SUMMARY

The present disclosure addresses the aforementioned needs in the art, as will now be summarized and then further described in detail below.

Some variations provide a method of pre-lithiating a lithium-ion battery containing lithium vanadium oxide, the method comprising:
(a) providing a lithium-ion battery configured with an electrode structure comprising (i) one or more porous anode layers, wherein each of the porous anode layers comprises a porous anode active-material layer disposed on a porous anode current-collector layer, and wherein the porous anode active-material layer contains vanadium oxide and/or lithium vanadium oxide having an initial degree of lithiation; (ii) one or more porous cathode layers, wherein each of the porous cathode layers comprises a porous cathode active-material layer disposed on a porous cathode current-collector layer; (iii) one or more separator layers interposed between adjacent porous anode layers and porous cathode layers; (iv) an electrolyte contained within the lithium-ion battery; (v) a first lithium-containing layer disposed on an end of the electrode structure; and (vi) optionally, a second lithium-containing layer disposed on another end of the electrode structure; and
(b) applying an external electrical potential to the lithium-ion battery to electrochemically transport lithium ions from the first lithium-containing layer and, if present, the second lithium-containing layer, to each of the porous anode active-material layers, thereby generating lithium vanadium oxide LiₐV_{b}O_{c}, wherein a=1-10, b=1-3, c=1-9, and a, b, and c are selected to charge-balance the LiₐV_{b}O_{c}.

In some embodiments, at least some of the LiₐV_{b}O_{c} has a disordered rocksalt structure in the Fm3̅m space group.

In some embodiments, the initial degree of lithiation is 0 prior to step (b). In other embodiments, the initial degree of lithiation is greater than 0 prior to step (b).

In some embodiments, the porous anode active-material layer has a porosity from about 15% to about 50%, such as from about 20% to about 40%.

In some embodiments, the porous anode active-material layer has an average anode pore size from about 0.01 microns to about 20 microns, such as from about 0.1 microns to about 5 microns.

In some embodiments, the porous anode current-collector layer has a porosity from about 1% to about 50%, such as from about 5% to about 15%.

In some embodiments, the porous anode current-collector layer has an average pore size from about 0.01 microns to about 200 microns, such as from about 1 micron to about 20 microns.

In some embodiments, the porous anode current-collector layer is a porous copper foil, a nickel foil, or a copper-nickel foil.

In some embodiments, the porous cathode active-material layer has a porosity from about 15% to about 50%, such as from about 20% to about 40%.

In some embodiments, the porous cathode active-material layer has an average pore size from about 0.01 microns to about 20 microns, such as from about 0.1 microns to about 5 microns.

In some embodiments, the porous cathode current-collector layer has a porosity from about 1% to about 50%, such as from about 5% to about 15%.

In some embodiments, the porous cathode current-collector layer has an average cathode-current-collector pore size from about 0.01 microns to about 200 microns, such as from about 1 micron to about 20 microns.

In some embodiments, the porous cathode current-collector layer is a porous aluminum foil.

In some embodiments, in step (a), the first lithium-containing layer consists of a lithium foil.

In some embodiments, in step (a), the first lithium-containing layer consists of lithium particles disposed on a substrate surface, or lithium coated onto a substrate surface. The substrate surface may be a surface of a metal substrate, a surface of a carbon substrate, or a surface of a composite metal-carbon substrate, for example.

The electrode structure may be configured as an electrode stack. In some embodiments, the electrode stack is a vertical electrode stack. The vertical electrode stack may contain 3 or more anode-separator-cathode layer assemblies, stacked on top of each other.

In some embodiments, the electrode structure is configured as an electrode Z-stack.

In some embodiments, the electrode structure is configured as a winded electrode roll. The winded electrode roll may be a cylindrically winded electrode roll or a prismatically winded electrode roll, for example.

In some embodiments, the one or more separator layers consist of a single contiguous layer interposed between all adjacent porous anode layers and porous cathode layers.

In some embodiments, step (b) utilizes a two-electrode configuration, wherein the first lithium-containing layer does not operate as an independent electrode, and wherein the second lithium-containing layer, if present, does not operate as an independent electrode. In certain embodiments, the amount of the lithium ions transported in step (b) is regulated by the thickness of the first lithium-containing layer and by the thickness of the second lithium-containing layer, if present. In certain embodiments, the amount of the lithium ions transported in step (b) is regulated by the total quantity of lithium contained within the first lithium-containing layer and the second lithium-containing layer, if present. In certain embodiments, all lithium present within the first lithium-containing layer is transported in step (b) to the porous anode layers.

In some embodiments, the second lithium-containing layer is present, and all lithium present within the second lithium-containing layer is transported in step (b) to the porous anode layers.

In some embodiments, step (b) utilizes a three-electrode configuration, wherein during step (b), the first lithium-containing layer operates as a third electrode, and wherein the porous anode layers operate as working electrodes. In certain embodiments, during step (b), the amount of the lithium ions transported in step (b) is precisely managed by electrically controlling the porous anode layers. Less than all lithium present within the first lithium-containing layer may be transported in step (b) to the porous anode layers. Optionally, following step (b), the first lithium-containing layer may be used as a reference electrode during lithium-ion battery operation. In some embodiments, all lithium present within the first lithium-containing layer is transported in step (b) to the porous anode layers.

In some embodiments when the second lithium-containing layer is present, during step (b), the second lithium-containing layer operates as a third electrode, and the porous anode layers operate as working electrodes. In certain embodiments, less than all lithium present within the second lithium-containing layer is transported in step (b) to the porous anode layers. In other embodiments, all lithium present within the second lithium-containing layer is transported in step (b) to the porous anode layers.

In some embodiments, step (b) employs a controlled discharge sequence. The controlled discharge sequence may be characterized by a progressively decreasing current rate. The controlled discharge sequence may employ a constant current, constant voltage discharge strategy.

In some embodiments utilizing a three-electrode configuration, step (b) may employ externally shorting the first lithium-containing layer with a vanadium oxide electrode using a resistor to control the current and a voltage meter to monitor the voltage. The vanadium oxide electrode is optionally a lithiated vanadium oxide electrode. When the second lithium-containing layer is present, step (b) may employ externally shorting the second lithium-containing layer with the vanadium oxide electrode, using the resistor to control the current and the voltage meter, to monitor the voltage.

In certain embodiments, the second lithium-containing layer is present, and step (b) employs externally shorting the second lithium-containing layer with a second vanadium oxide electrode, using a second resistor to control the current and a second voltage meter to monitor the voltage.

In some embodiments, the lithium-ion battery is in a pouch-cell configuration, a coin-cell configuration, a cylindrical-cell configuration, a prismatic-cell configuration, or a configuration using an irregular cell shape.

In some embodiments, the lithium vanadium oxide LiₐV_{b}O_{c} is doped with one or more dopants M, and wherein M is selected from the group consisting of Na, K, Be, Mg, Ca, Zn, Fe, Co, Ni, Cu, Ag, Sc, B, Y, Al, La, Si, Ge, Sn, Ti, Zr, Mn, P, Nb, Ta, Cr, Mo, W, Se, N, S, F, Cl, Br, I, and combinations thereof.

In some embodiments, the lithium-ion battery has an anode cumulative discharge capacity from about 1 mA·h/g to about 1700 mA·h/g after the method. In certain embodiments, the anode cumulative discharge capacity is at least 100 mA·h/g after the method, such as at least 500 mA·h/g after the method.

Other variations of the invention provide a method of pre-lithiating an electrode material for a lithium-ion battery, the method comprising:
(a) providing an electrode precursor material having an initial degree of lithiation, wherein the electrode precursor material is in powder form;
(b) providing a lithium-containing layer disposed adjacent to the electrode precursor material, or configured in lithium mass transport with the electrode precursor material, wherein a Li transport path exists between the lithium-containing layer and the electrode precursor material;
(c) placing a liquid lithium-ion conductor into the Li transport path;
(d) reacting lithium, initially contained in the lithium-containing layer, with the electrode precursor material, using effective lithiation reaction conditions, thereby generating a lithiated electrode material; and
(e) recovering the lithiated electrode material, which may utilize washing, filtering or other separation, drying, thermal treatment at a temperature up to about 300° C., or a combination thereof.

In some embodiments, the lithiated electrode material is a lithiated anode material. The lithiated anode material may be selected from the group consisting of lithiated vanadium oxide, lithiated silicon, lithiated silicon oxide, lithiated silicon/C, lithiated graphite, lithiated carbon, lithiated hard carbon, lithiated soft carbon, lithiated aluminum, lithiated magnesium, lithiated zinc, lithiated tin, lithiated tin oxide, lithiated phosphorus, and combinations thereof.

In some embodiments, the electrode precursor material contains vanadium oxide and/or lithium vanadium oxide, wherein the lithiated anode material contains lithium vanadium oxide LiₐV_{b}O_{c}, and wherein a=1-10, b=1-3, c=1-9, and a, b, and c are selected to charge-balance the LiₐV_{b}O_{c}. At least some of the LiₐV_{b}O_{c} may have a disordered rocksalt structure in the Fm3̅m space group.

In some embodiments, the lithiated electrode material is a lithiated cathode material. The lithiated cathode material may be selected from the group consisting of lithiated sulfur, lithiated sulfurized polyacrylonitrile, lithiated ferric fluoride, lithiated metal fluoride, lithiated metal sulfide, lithiated lithium nickel manganese cobalt oxide (LiNiₓCo_{y}Mn_{z}O₂ (x+y+z=1)), lithiated lithium nickel manganese oxide (LiNiₓMn_{z}O₂ (x+z=1)), lithiated lithium nickel cobalt oxide (LiNiₓCo_{y}O₂ (x+y=1)), lithiated lithium nickel cobalt aluminum oxide (LiNiₓCo_{y}Al_{z}O₂ (x+y+z=1)), lithiated lithium cobalt oxide (LiCoO₂), lithiated lithium nickel manganese spinel oxide (LiMnₓNi_{y}O₄ (x+y=2)), lithiated lithium manganese spinel oxide (LiMn₂O₄), lithiated lithium iron phosphate (LiFePO₄), lithiated lithium iron manganese phosphate (LiFeₓMn_{y}PO₄ (x+y=1)), lithiated lithium manganese spinel oxide (Li₂MnO₃), lithiated lithium-rich manganese-rich layered oxide (aLiNiₓCo_{y}Mn_{z}O₂·(1−a)Li₂MnO₃ (0<a<1 and x+y+z=1)), LiF, Li₂S, Li₂O, Li₂O₂, and combinations thereof.

In some embodiments, the initial degree of lithiation is 0 prior to step (d). In other embodiments, the initial degree of lithiation is greater than 0 prior to step (d).

In some embodiments, the electrode precursor material is doped with one or more dopants M, and wherein M is selected from the group consisting of Na, K, Be, Mg, Ca, Zn, Fe, Co, Ni, Cu, Ag, Sc, B, Y, Al, La, Si, Ge, Sn, Ti, Zr, Mn, P, Nb, Ta, Cr, Mo, W, Se, N, S, F, Cl, Br, I, and combinations thereof.

In some embodiments, the lithium-containing layer is in the form of a foil, an ingot, a powder, a wire, or a combination thereof.

In some embodiments, the liquid lithium-ion conductor is prepared by dissolving one or more lithium-containing salts into a non-aqueous solvent. The lithium-containing salts may be selected from the group consisting of LiPF₆, LiClO₄, LiBF₄, LiAsF₆, lithium bis(trifluoromethanesulfonyl)imide, lithium bis(fluorosulfonyl)imide, and combinations thereof. The non-aqueous solvent may be selected from the group consisting of carbonates, ethers, esters, alcohols, ionic liquids, and combinations thereof.

The effective lithiation reaction conditions may include a lithiation temperature selected from about −40° C. to about 200° C. The effective lithiation reaction conditions may include a lithiation reaction time selected from about 0.1 hr to about 168 hr. The effective lithiation reaction conditions may include a lithiation pressure selected from about 0.01 MPa to about 10 MPa. The effective lithiation reaction conditions may include a lithiation pH selected from about 5 to about 14.

In some embodiments, the effective lithiation reaction conditions include a reaction atmosphere of an inert gas, such as Ar, He, and/or N₂. In some embodiments, the effective lithiation reaction conditions include a reaction atmosphere of dry air. Other atmospheres may be used for the lithiation reaction in step (d).

In some embodiments, lithium reaction with the electrode precursor material in step (d) is promoted by the presence of an electron conductor, an ion conductor, an electron-ion conductor, or a combination thereof, disposed on, or within, the electrode precursor material. The electron-ion conductor may contain carbon, such as carbon selected from the group consisting of amorphous carbon, carbon nanotubes, carbon black, vapor-growth carbon fiber, ultra-fine carbon, graphene, graphite, hard carbon, soft carbon, sp carbon, sp² carbon, sp³ carbon, and combinations thereof.

Still other variations of the invention provide a method of pre-lithiating an electrode material for a lithium-ion battery, the method comprising:
(a) providing an electrode precursor material having an initial degree of lithiation, wherein the electrode precursor material is in powder form;
(b) providing a solid lithium-containing material;
(c) blending and mechanically agitating the electrode precursor material and the solid lithium-containing material;
(d) simultaneously with step (c), or sequentially after step (c), reacting lithium, initially contained in the solid lithium-containing material, with the electrode precursor material, using effective lithiation reaction conditions, thereby generating a lithiated electrode material; and
(e) recovering the lithiated electrode material, which may utilize washing, filtering or other separation, drying, thermal treatment at a temperature up to about 300° C., or a combination thereof.

In some embodiments, the lithiated electrode material is a lithiated anode material. The lithiated anode material may be selected from the group consisting of lithiated vanadium oxide, lithiated silicon, lithiated silicon oxide, lithiated silicon/C, lithiated graphite, lithiated carbon, lithiated hard carbon, lithiated soft carbon, lithiated aluminum, lithiated magnesium, lithiated zinc, lithiated tin, lithiated tin oxide, lithiated phosphorus, and combinations thereof.

In some embodiments, the electrode precursor material contains vanadium oxide and/or lithium vanadium oxide, wherein the lithiated anode material contains lithium vanadium oxide LiₐV_{b}O_{c}, and wherein a=1-10, b=1-3, c=1-9, and a, b, and c are selected to charge-balance the LiₐV_{b}O_{c}. At least some of the LiₐV_{b}O_{c} may have a disordered rocksalt structure in the Fm3̅m space group.

In some embodiments, the lithiated electrode material is a lithiated cathode material. The lithiated cathode material may be selected from the group consisting of lithiated sulfur, lithiated sulfurized polyacrylonitrile, lithiated ferric fluoride, lithiated metal fluoride, lithiated metal sulfide, lithiated lithium nickel manganese cobalt oxide (LiNiₓCo_{y}Mn_{z}O₂ (x+y+z=1)), lithiated lithium nickel manganese oxide (LiNiₓMn_{z}O₂ (x+z=1)), lithiated lithium nickel cobalt oxide (LiNiₓCo_{y}O₂ (x+y=1)), lithiated lithium nickel cobalt aluminum oxide (LiNiₓCo_{y}Al_{z}O₂ (x+y+z=1)), lithiated lithium cobalt oxide (LiCoO₂), lithiated lithium nickel manganese spinel oxide (LiMnₓNi_{y}O₄ (x+y=2)), lithiated lithium manganese spinel oxide (LiMn₂O₄), lithiated lithium iron phosphate (LiFePO₄), lithiated lithium iron manganese phosphate (LiFeₓMn_{y}PO₄ (x+y=1)), lithiated lithium manganese spinel oxide (Li₂MnO₃), lithiated lithium-rich manganese-rich layered oxide (aLiNiₓCo_{y}Mn_{z}O₂·(1−a)Li₂MnO₃ (0<a<1 and x+y+z=1)), LiF, Li₂S, Li₂O, Li₂O₂, and combinations thereof.

In some embodiments, the initial degree of lithiation is 0 prior to step (d). In other embodiments, the initial degree of lithiation is greater than 0 prior to step (d).

In some embodiments, the electrode precursor material is doped with one or more dopants M, and wherein M is selected from the group consisting of Na, K, Be, Mg, Ca, Zn, Fe, Co, Ni, Cu, Ag, Sc, B, Y, Al, La, Si, Ge, Sn, Ti, Zr, Mn, P, Nb, Ta, Cr, Mo, W, Se, N, S, F, Cl, Br, I, and combinations thereof.

In some embodiments, the lithium-containing layer is in the form of a foil, an ingot, a powder, or a combination thereof.

In some embodiments, the solid lithium-containing material is pure lithium. In other embodiments, the solid lithium-containing material is a lithium compound. The lithium compound may be a lithium-ion conductor, such as one selected from the group consisting of oxides, sulfides, phosphates, argyrodites,
β-aluminas, LISICON, garnets, NASICON, perovskites, antiperovskites, lithium nitrides, lithium hydrides, lithium phosphidotrielates and phosphidotetrelates, lithium metal halides, LIPON, lithium thiophosphates, LiAlH₄, LiBH₄, and combinations thereof.

In some embodiments, the solid lithium-containing material is a powder with an average particle size selected from about 0.01 microns to about 20 microns.

In some embodiments, the electrode precursor material has an average particle size selected from about 0.05 microns to about 20 microns.

Step (c) may employ ball milling or another type of milling, such as bead milling, roll jar milling, or a combination thereof. In some embodiments, after step (c), the mechanically agitated material consisting of the electrode precursor material and the solid lithium-containing material has an average particle size selected from about 0.05 microns to about 20 microns.

In some embodiments, the effective lithiation reaction conditions include a lithiation temperature selected from about −40° C. to about 200° C.; a lithiation reaction time selected from about 0.1 hr to about 168 hr; and/or a lithiation pressure selected from about 0.01 MPa to about 10 MPa.

In some embodiments, the effective lithiation reaction conditions include a reaction atmosphere of an inert gas, such as Ar, He, and/or N₂. In some embodiments, the effective lithiation reaction conditions include a reaction atmosphere of dry air. Other atmospheres may be used for the lithiation reaction in step (d).

In some embodiments, lithium reaction with the electrode precursor material in step (d) is promoted by the presence of an electron conductor, an ion conductor, an electron-ion conductor, or a combination thereof, disposed on, or within, the electrode precursor material. In these or other embodiments, lithium reaction with the electrode precursor material in step (d) is promoted by the presence of an electron conductor, an ion conductor, an electron-ion conductor, or a combination thereof, disposed on, or within, the solid lithium-containing material. An electron-ion conductor may contain carbon, such as carbon selected from the group consisting of amorphous carbon, carbon nanotubes, carbon black, vapor-growth carbon fiber, ultra-fine carbon, graphene, graphite, hard carbon, soft carbon, sp carbon, sp² carbon, sp³ carbon, and combinations thereof.

### BRIEF DESCRIPTION OF THE FIGURES

FIG. 1 is a schematic illustration of an exemplary lithium-ion battery in a coin- cell configuration, in some embodiments of the invention.

FIG. 2 is a schematic illustration of a porous cathode layer and a porous anode layer, in some embodiments of the invention.

FIG. 3 is a schematic illustration of a two-electrode design for pre-lithiation of a lithium-ion battery, in some embodiments of the invention.

FIG. 4 is a schematic illustration of a three-electrode design for pre-lithiation of a lithium-ion battery, in some embodiments of the invention.

FIG. 5 is a schematic illustration of a pouch-cell configuration using a three-electrodes system for pre-lithiation of a porous anode active-material layer, in some embodiments of the invention.

FIG. 6 shows experimental data for Example 1, demonstrating a controlled discharge sequence with progressively decreasing current rate for pre-lithiation in a coin-cell configuration.

FIG. 7 shows experimental data for Example 2, demonstrating a controlled discharge sequence with a constant current, constant voltage discharge strategy for pre-lithiation in a coin-cell configuration.

FIG. 8 shows experimental data for Example 3, demonstrating pre-lithiation partitioned into multiple sequential stages, using a three-electrode pouch cell.

FIG. 9 shows experimental data for Example 4, demonstrating good capability at high current rates for a pre-lithiated pouch cell.

FIG. 10 shows experimental data for Example 4, demonstrating a specific discharge capacity of about 130 mA·h/g after 200 cycles for a pre-lithiated pouch cell.

FIG. 11 shows experimental data for Example 4, demonstrating a capacity retention of about 95% after 200 cycles for a pre-lithiated pouch cell.

FIG. 12 shows x-ray diffraction (XRD) data for powder synthesis of pre-lithiated electrode material using a liquid lithium-ion conductor (Example 5) or a solid lithium-ion conductor (Example 6).

FIG. 13 shows x-ray diffraction (XRD) data for powder synthesis of pre-lithiated electrode material using a solid approach at different scales (Example 7).

### DETAILED DESCRIPTION OF EMBODIMENTS

The principles, methods, compositions, and systems of the present disclosure will be described in detail by reference to various non-limiting embodiments of the technology.

This description will enable one skilled in the art to make and use the technology, and it describes several embodiments, adaptations, variations, alternatives, and uses of the technology. These and other embodiments, features, and advantages of the present technology will become more apparent to those skilled in the art when taken with reference to the following detailed description in conjunction with the accompanying drawings.

Unless defined otherwise, all technical and scientific terms used herein have the same meaning as is commonly understood by one of ordinary skill in the art to which this technology belongs.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising” (synonymously, “including”), “consisting of,” and “consisting essentially of,” where one of these three terms is used herein, the presently disclosed and claimed subject matter may include the use of either of the other two terms, except when used in Markush groups. Thus in some embodiments not otherwise explicitly recited, any instance of “comprising” may be replaced by “consisting of” or, alternatively, by “consisting essentially of.” The term “including” should be read as meaning “including, without limitation” or the like; the term “example” is used to provide exemplary instances of the item in discussion, not an exhaustive or limiting list thereof.

Adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this patent application refers to technologies that would be apparent or known to one of ordinary skill in the art, such technologies encompass those apparent or known to the skilled artisan now or at any time in the future.

In this specification, hypotheses and theories are disclosed, it being understood that the present invention is not limited to the proposed hypotheses and theories.

In this specification, with respect to a concentration of a component within a composition, a percentage is in reference to weight percent (wt %), unless indicated otherwise.

As used in this specification and the appended claims, the singular forms “a,” “an,” and “the” include plural referents unless the context clearly indicates otherwise. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

In this specification, “pre-lithiation” (equivalently, “lithiation”) should be broadly construed to mean the addition of lithium atoms, lithium ions, or molecules containing lithium, via various mechanisms. Lithiation mechanisms may include chemical bond formation, ionic bond formation, lithium insertion into a crystal structure, lithium intercalation into crystal lattices, chemical adsorption, chemical absorption, or a combination thereof.

In prior work, it was demonstrated that a disordered rocksalt Li₃V₂O₅ anode has a cell voltage much higher than commercial fast-charging lithium titanate anode or other intercalation anode candidates. Li₃V₂O₅ contains lithium ions within its crystal structure, which allows the material to reversibly store and release lithium ions during charge and discharge cycles. The Li₃V₂O₅ can be made from a very earth-abundant material, vanadium oxide (V₂O₅). In order to introduce lithium atoms to vanadium oxide, a lithiation reaction is required, inserting Li ions into the crystal structure of V₂O₅.

However, existing lithiation methods are beset by various challenges and limitations, such as non-uniformity, over-lithiation, poor compatibility with other battery components, and scaling challenges, to name a few. Variations of the present invention are predicated on various, distinct technical solutions to the problem of effectively pre-lithiating electrodes. In some variations, porous electrodes are designed to ameliorate the V₂O₅ pre-lithiation procedure, thereby enhancing overall efficiency.

Other variations utilize a liquid lithium-ion conductor to carry out a reaction of lithium, initially in a lithium-containing layer, with an electrode precursor material and an electron conductor, an ion conductor, a combined electron-ion conductor, or a combination thereof. Still other variations utilize a solid lithium-containing material, mechanically agitated with an electrode precursor material, to carry out a reaction of the lithium with the electrode precursor material and an electron conductor, an ion conductor, a combined electron-ion conductor, or a combination thereof. These variations are not limited to lithium vanadium oxide anode materials; other anode or cathode materials may be pre-lithiated according to the techniques disclosed herein.

Some variations provide a method of pre-lithiating a lithium-ion battery containing lithium vanadium oxide, the method comprising:
(a) providing a lithium-ion battery configured with an electrode structure comprising (i) one or more porous anode layers, wherein each of the porous anode layers comprises a porous anode active-material layer disposed on a porous anode current-collector layer, and wherein the porous anode active-material layer contains vanadium oxide and/or lithium vanadium oxide having an initial degree of lithiation; (ii) one or more porous cathode layers, wherein each of the porous cathode layers comprises a porous cathode active-material layer disposed on a porous cathode current-collector layer; (iii) one or more separator layers interposed between adjacent porous anode layers and porous cathode layers; (iv) an electrolyte contained within the lithium-ion battery; (v) a first lithium-containing layer disposed on an end of the electrode structure; and (vi) optionally, a second lithium-containing layer disposed on another end of the electrode structure; and
(b) applying an external electrical potential to the lithium-ion battery to electrochemically transport lithium ions from the first lithium-containing layer and, if present, the second lithium-containing layer, to each of the porous anode active-material layers, thereby generating lithium vanadium oxide LiₐV_{b}O_{c}, wherein a=1-10, b=1-3, c=1-9, and a, b, and c are selected to charge-balance the LiₐV_{b}O_{c}.

In some embodiments, a dopant M is included in the porous anode active-material layer. The dopant M may be selected from the group consisting of Na, K, Be, Mg, Ca, Zn, Fe, Co, Ni, Cu, Ag, Sc, B, Y, Al, La, Si, Ge, Sn, Ti, Zr, Mn, P, Nb, Ta, Cr, Mo, W, Se, N, S, F, Cl, Br, I, and combinations thereof, for example. The dopants may include one or more monovalent, divalent, trivalent, tetravalent, pentavalent, or hexavalent dopants. Multiple dopants may be present.

When a dopant M is added, step (b) may generate doped lithium vanadium oxide LiₐV_{b}O_{c}M_{d}, wherein a=1-10, b=1-3, c=1-9, and d=0.001-3, wherein a=1-10, b=1-3, c=1-9, and a, b, c, and d are selected to charge-balance the LiₐV_{b}O_{c}M_{d}.

In some embodiments, a dopant M is added during step (b), in which not only Li ions but also M atoms or ions are transported to the porous anode active-material layers.

A dopant M may be introduced into a porous anode active-material layer through various methods depending on the desired properties and the type of dopant selected. Common dopants include transition metals (e.g., Ti, Cr, Mn, Fe, Co, Ni, or Cu), alkali or alkaline earth metals (e.g., Na, Mg, or Ca), and non-metals (e.g., P, N, or F). These dopants are typically used to enhance the electronic conductivity, improve the Li ion diffusivity, lower the operation potential, stabilize the crystal structure, and/or improve the electrochemical performance for energy-storage applications.

Dopants may be introduced during precursor preparation. For example, dopants such as Mg or Na may be added to the vanadium precursor solution (e.g., ammonium metavanadate or vanadium oxytrichloride) in the form of magnesium nitrate, sodium hydroxide, or corresponding salts. This method ensures uniform mixing of the dopant ions at the atomic level before the synthesis process, forming doped V₂O₅ upon thermal decomposition.

Dopants may be introduced during thermal treatment/annealing. For example, transition metals such as Cr, Mn, or Ni may be added in the form of oxides (e.g., Cr₂O₃, MnO₂, or NiO) or metal salts (e.g., nitrates or acetates). These materials may be mechanically mixed with V₂O₅ powder and annealed at specific temperatures (e.g., 300-500° C.) to promote diffusion of the dopant ions into the V₂O₅ lattice.

Dopants may be introduced via post-synthesis doping. Non-metals such as P, N, or F may be introduced into V₂O₅ through chemical treatments. For example, phosphorous can be incorporated via phosphoric acid vapor treatment, while nitrogen doping can be achieved through annealing in an ammonia (NH₃) atmosphere. Fluorine can be introduced by exposing the V₂O₅ material to fluorinated precursors or gaseous fluorine sources.

Each doping method and dopant selection allows for the tuning of V₂O₅ (and, when lithiated, LiₐV_{b}O_{c}) properties such as improved electronic conductivity, higher ion diffusivity, reduced working potential, and enhanced cycling stability, making the material more suitable for applications in lithium ion batteries, supercapacitors, and catalytic processes.

In some embodiments, at least some of the LiₐV_{b}O_{c} has a disordered rocksalt structure in the Fm3̅m space group.

In some embodiments, the initial degree of lithiation is 0 prior to step (b). In other embodiments, the initial degree of lithiation is greater than 0 prior to step (b).

In some embodiments, the porous anode active-material layer has a porosity from about 15% to about 50%. In certain embodiments, the porous anode active-material layer has a porosity from about 20% to about 40%.

In some embodiments, the porous anode active-material layer has an average anode pore size from about 0.01 microns to about 20 microns. In certain embodiments, the porous anode active-material layer has an average anode pore size from about 0.1 microns to about 5 microns.

In some embodiments, the porous anode current-collector layer has a porosity from about 1% to about 50%. In certain embodiments, the porous anode current-collector layer has a porosity from about 5% to about 15%.

In some embodiments, the porous anode current-collector layer has an average pore size from about 0.01 microns to about 200 microns. In certain embodiments, the porous anode current-collector layer has an average pore size from about 1 micron to about 20 microns.

In some embodiments, the porous anode current-collector layer is a porous copper foil, a nickel foil, or a copper-nickel foil.

In some embodiments, the porous cathode active-material layer has a porosity from about 15% to about 50%. In certain embodiments, the porous cathode active-material layer has a porosity from about 20% to about 40%.

In some embodiments, the porous cathode active-material layer has an average pore size from about 0.01 microns to about 20 microns. In certain embodiments, the porous cathode active-material layer has an average pore size from about 0.1 microns to about 5 microns.

In some embodiments, the porous cathode current-collector layer has a porosity from about 1% to about 50%. In certain embodiments, the porous cathode current-collector layer has a porosity from about 5% to about 15%.

In some embodiments, the porous cathode current-collector layer has an average cathode-current-collector pore size from about 0.01 microns to about 200 microns. In certain embodiments, the porous cathode current-collector layer has an average cathode-current- collector pore size from about 1 micron to about 20 microns.

In some embodiments, the porous cathode current-collector layer is a porous aluminum foil.

In some embodiments, in step (a), the first lithium-containing layer consists of a lithium foil. In other embodiments, in step (a), the first lithium-containing layer consists of lithium particles disposed on a substrate surface, such as lithium coated onto a substrate surface. The substrate surface may be a surface of a substrate selected from a metal substrate, a carbon substrate, or a composite metal-carbon substrate, for example.

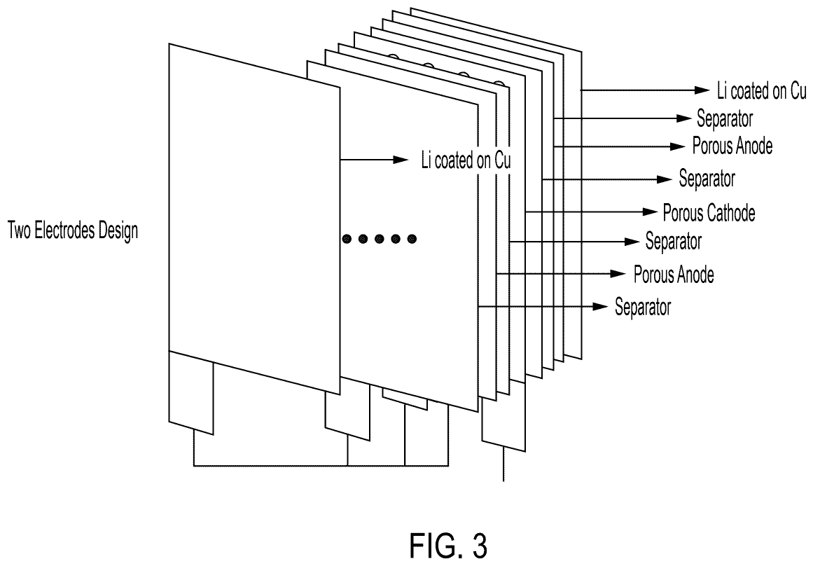

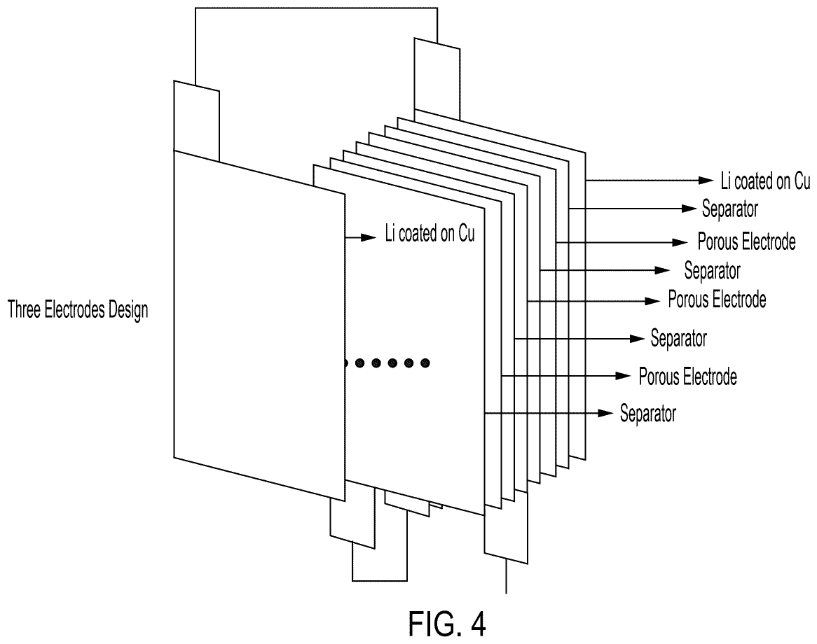

In some embodiments, the electrode structure is configured as an electrode stack. In some embodiments, the electrode stack is a vertical electrode stack, also known in the art as a “single-sheet stack” since single layers are stacked on top of each other (e.g., see FIGS. 3 and 4). In various embodiments, a vertical electrode stack contains 2, 3, 4, 5 or more anode-separator-cathode layer assemblies, stacked on top of each other.

In some embodiments, the electrode structure is configured as an electrode Z-stack. A “Z-stack” is made by Z-stacking (also referred to as Z-fold stacking or Z-folding) of anode layers and cathode layers alternatively with a separator layer. An electrode Z-stack may be made by moving the separator between stacking platforms in a zigzag pattern, allowing the anode and cathode to cross-stack.

In some embodiments, the electrode structure is configured as a winded electrode roll. The winded electrode roll may be a cylindrically winded electrode roll or a prismatically winded electrode roll, for example. A cylindrically winded electrode roll is also known in the art as a “jelly roll”. The winded electrode roll may be winded in a configuration that is not classified as either cylindrical or prismatic, instead being an irregular winded roll pattern.

In some embodiments, the one or more separator layers consist of a single contiguous layer interposed between all adjacent porous anode layers and porous cathode layers.

In some embodiments, step (b) utilizes a two-electrode configuration, in which case the first lithium-containing layer does not operate as an independent electrode, and the second lithium-containing layer, if present, also does not operate as an independent electrode.

In some embodiments utilizing a two-electrode configuration, the amount of the lithium ions transported in step (b) is regulated by the thickness of the first lithium-containing layer and by the thickness of the second lithium-containing layer, if present.

In some embodiments utilizing a two-electrode configuration, the amount of the lithium ions transported in step (b) is regulated by the total quantity of lithium contained within the first lithium-containing layer and the second lithium-containing layer, if present.

In some embodiments utilizing a two-electrode configuration, all lithium present within the first lithium-containing layer is transported in step (b) to the porous anode layers. In these or other embodiments, the second lithium-containing layer is present, and all lithium present within the second lithium-containing layer may be transported in step (b) to the porous anode layers.

In some embodiments, step (b) utilizes a three-electrode configuration, in which case during step (b), the first lithium-containing layer operates as a third electrode, and the porous anode layers operate as working electrodes.

In some embodiments utilizing a three-electrode configuration, during step (b), the amount of the lithium ions transported in step (b) is precisely managed by electrically controlling the porous anode layers.

In some embodiments utilizing a three-electrode configuration, less than all lithium present within the first lithium-containing layer is transported in step (b) to the porous anode layers. In these embodiments, following step (b), the first lithium-containing layer is optionally used as a reference electrode during lithium-ion battery operation.

In some embodiments utilizing a three-electrode configuration, all lithium present within the first lithium-containing layer is transported in step (b) to the porous anode layers.

In some embodiments utilizing a three-electrode configuration, the second lithium-containing layer is present. During step (b), the second lithium-containing layer may operate as a third electrode, while the porous anode layers operate as working electrodes.

In some embodiments utilizing a three-electrode configuration as well as a second lithium-containing layer, less than all lithium present within the second lithium-containing layer is transported in step (b) to the porous anode layers.

In some embodiments utilizing a three-electrode configuration as well as a second lithium-containing layer, all lithium present within the second lithium-containing layer is transported in step (b) to the porous anode layers.

In some embodiments utilizing a three-electrode configuration, step (b) employs a controlled discharge sequence. For example, the controlled discharge sequence may be characterized by a progressively decreasing current rate. The controlled discharge sequence may employ a constant current, constant voltage discharge strategy.

In some embodiments utilizing a three-electrode configuration, step (b) employs externally shorting the first lithium-containing layer with a vanadium oxide electrode using a resistor to control the current and a voltage meter to monitor the voltage. The vanadium oxide electrode may be a V₂O₅ electrode, for example. The vanadium oxide electrode may be a lithiated vanadium oxide electrode, such as LiV₂O₅, for example. In various embodiments employing external shorting, the vanadium oxide electrode is given by the stoichiometry LiₐV_{b}O_{c}, wherein a=0-3, b=1-3, c=1-9, and a, b, and c are selected to charge-balance the LiₐV_{b}O_{c}. The value of a can be 0, 0.1, 0.2, 0.3, 0.4, 0.5, 0.6, 0.7, 0.8, 0.9, or 1.0, for example.

When the second lithium-containing layer is present, step (b) may employ externally shorting the second lithium-containing layer with the vanadium oxide electrode or with a second vanadium oxide electrode, using the resistor or a second resistor to control the current and the voltage meter or a second voltage meter to monitor the voltage. In various embodiments employing external shorting and when the second lithium-containing layer is present, the second vanadium oxide electrode is given by the stoichiometry LiₐV_{b}O_{c}, wherein a=0-3, b=1-3, c=1-9, and a, b, and c are selected to charge-balance the LiₐV_{b}O_{c}. The value of a can be 0, 0.1, 0.2, 0.3, 0.4, 0.5, 0.6, 0.7, 0.8, 0.9, or 1.0, for example. The stoichiometry of LiₐV_{b}O_{c} for the second vanadium oxide electrode is preferably the same as that for the (first) vanadium oxide electrode, to avoid cell non-uniformity.

In some preferred embodiments, the first lithium-containing layer and the second lithium-containing layer are welded together and electrically conductive with each other. In these embodiments, when the first lithium-containing layer is externally shorted, the second lithium-containing layer will be externally shorted as well. In these embodiments, step (b) may employ externally shorting the first and second lithium-containing layers with the vanadium oxide electrode, using the resistor to control the current and the voltage meter to monitor the voltage.

In various embodiments, the lithium-ion battery is in a pouch-cell configuration, a coin-cell configuration, a blade-cell configuration, a cylindrical-cell configuration, a prismatic-cell configuration, or a configuration using an irregular cell shape, for example.

Upon the completion of the pre-lithium process, whether using a two-electrode configuration or a three-electrode configuration, the anode and cathode are cycled for battery testing and measurements, or for actual battery usage.

In various embodiments, the lithium-ion battery has an anode cumulative discharge capacity from about 1 mA·h/g to about 1700 mA·h/g after the pre-lithiation method. In certain embodiments, the anode cumulative discharge capacity is at least 100 mA·h/g or at least 500 mA·h/g after the pre-lithiation method.

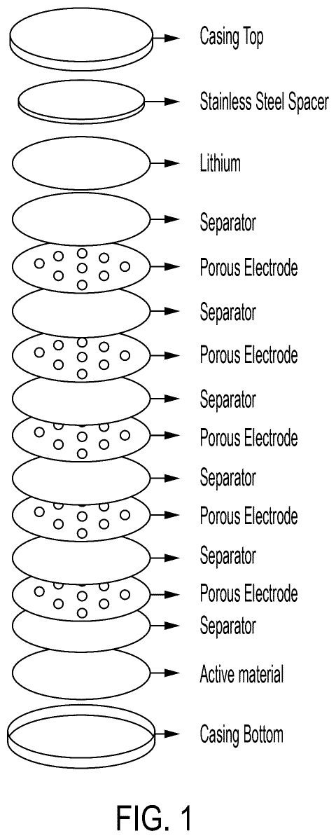

Some embodiments can be understood in reference to FIG. 1, which depicts an exemplary coin-cell configuration. As depicted in the illustrated diagram, the coin-cell configuration comprises a singular cast active material on copper foil substrates and five bilaterally cast electrodes on porous foil substrates. An individual separator is interposed between each electrode to prevent short circuit. The inclusion of the five electrodes emulates the conditions associated with pre-lithiation in multi-layer-electrode embodiments. A lithium chip is placed on the top of electrode and a stainless-steel spacer serves to optimize electrode-to-electrode contact. Within this half-cell design, the active-material electrode functions as the working electrode, and lithium foil works as counter electrodes.

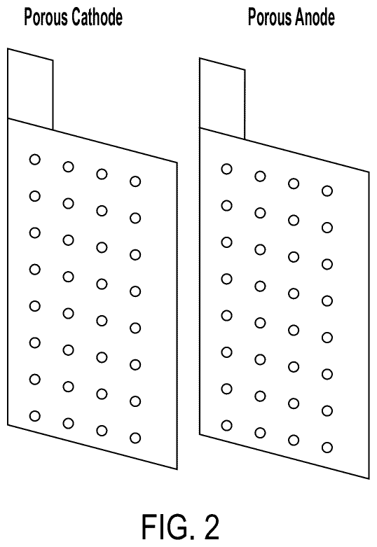

Some embodiments can be understood in reference to FIG. 2. The drawing of FIG. 2 generically depicts a porous cathode layer and a porous anode layer. The porous anode layer comprises a porous anode active-material layer disposed on a porous-anode current-collector layer. Likewise, the porous cathode layer comprises a porous cathode active-material layer disposed on a porous-cathode current-collector layer. Porous aluminum foil may be used as the porous-cathode current-collector layer, and porous copper may be used as the porous-anode current-collector layer, for example. In exemplary embodiments, but without limitation, the porous current-collector layers may possess pore sizes ranging from about 8 μm to about 12 μm with a porosity level within the range of about 5% to about 8%. The specifications for pore size and porosity can be tailored to meet the specific demands of various applications.

Porous current collectors provide significant benefits during the pre-lithiation process. Several advantages are associated with the use of porous current collectors:
1. Improved mass transport: The porous structure facilitates the efficient transport of ions and electrons through electrode layers along the shortest pathway. This mitigates the occurrence of concentration gradients, ensuring a more-uniform utilization of active materials.
2. Enhanced electrode-electrolyte interaction: Porous current collectors promote enhanced interaction between the electrode and the electrolyte, which facilitates improved ion transport and fosters more efficient electrochemical reactions.
3. Elevated charge and discharge rates: The internal resistance can be effectively reduced, thereby enabling higher charge and discharge rates.

Some embodiments can be understood in reference to FIG. 3, which is an illustration of pre-lithiation using a two-electrode design. Some embodiments can be understood in reference to FIG. 4, which is an illustration of pre-lithiation using a three-electrode design. As illustrated in the drawings of FIGS. 3 and 4, the battery configuration can accommodate either a two-electrode system or a three-electrode system, rendering the lithium-ion battery compatible with the pre-lithiation process.

In the two-electrode system (FIG. 3), two lithium-coated copper foils are strategically positioned at the upper and lower portions of the electrode structure, facilitating direct electrical connection with the anode during pre-lithiation. The amount of lithium introduced to the anode is systematically determined and regulated by the thickness of the lithium foil employed. After a certain time, the lithium foil will have been entirely consumed, resulting in the controlled infusion of a predetermined amount of lithium into the anode.

A three-electrode system (FIG. 4) employs controlled electrochemical deposition of lithium ions onto the anode. Within this system, lithium foils are functionally integrated as the third electrode. During the pre-lithiation phase, the anode operates as the working electrode, while the lithium foil serves as the counter electrode. An external electrical potential is applied between the anode and the lithium foil. This potential difference initiates the migration of lithium ions from the lithium foil onto the anode. A significant advantage of the three-electrode system resides in the precise control it affords over the quantity of lithium introduced. Furthermore, the three-electrode system is expected to be safer compared with the two-electrode system. Finally, the three-electrode system may utilize controlled external shorting as described above.

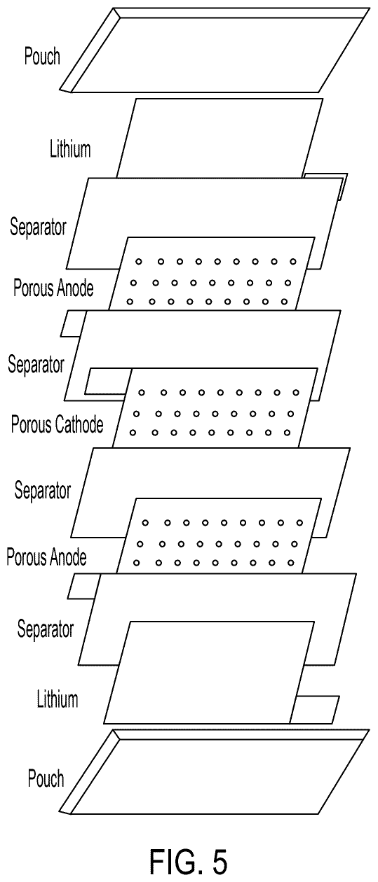

Certain embodiments can be understood in reference to FIG. 5, which is a pouch-cell configuration using a three-electrodes system for pre-lithiation of the porous anode active-material layer. This pouch-cell configuration is employed for the Examples described below.

Some variations of the technology provide a lithium-ion battery (regardless how it is pre-lithiated) comprising:
a first porous anode layer comprising a first porous anode active-material layer disposed on a first porous anode current-collector layer, wherein the first porous anode current-collector layer has an anode-current-collector porosity from about 1% to about 50%, and wherein the first porous anode current-collector layer has an average anode-current-collector pore size from about 0.01 microns to about 200 microns;
a first porous cathode layer comprising a first porous cathode active-material layer disposed on a first porous cathode current-collector layer, wherein the first porous cathode current-collector layer has a cathode-current-collector porosity from about 1% to about 50%, and wherein the first porous cathode current collector layer has an average cathode-current-collector pore size from about 0.01 microns to about 200 microns;
a first separator layer interposed between the first porous anode layer and the first porous cathode layer;
optionally, a first lithium-containing layer disposed in lithium-ion conduction but not in electron conduction with said first porous anode layer; and
optionally, an electrolyte,
wherein the first porous anode active-material layer contains lithium vanadium oxide LiₐV_{b}O_{c}, wherein a=1-10, b=1-3, c=1-9, and a, b, and c are selected to charge-balance the LiₐV_{b}O_{c}.

Some variations of the technology provide a lithium-ion battery (regardless how it is pre-lithiated) comprising:
a first porous anode layer comprising a first porous anode active-material layer disposed on a first porous anode current-collector layer, wherein the first porous anode current-collector layer has an anode-current-collector porosity from about 5% to about 15%, and/or wherein the first porous anode current-collector layer has an average anode-current-collector pore size from about 1 micron to about 20 microns;
a first porous cathode layer comprising a first porous cathode active-material layer disposed on a first porous cathode current-collector layer, wherein the first porous cathode current-collector layer has a cathode-current-collector porosity from about 1% to about 50%, and wherein the first porous cathode current collector layer has an average cathode-current-collector pore size from about 0.01 microns to about 200 microns;
a first separator layer interposed between the first porous anode layer and the first porous cathode layer;
optionally, a first lithium-containing layer disposed in lithium-ion conduction but not in electron conduction with said first porous anode layer; and
optionally, an electrolyte,
wherein the first porous anode active-material layer contains lithium vanadium oxide LiₐV_{b}O_{c}, wherein a=1-10, b=1-3, c=1-9, and a, b, and c are selected to charge-balance the LiₐV_{b}O_{c}.

Some variations of the technology provide a lithium-ion battery (regardless how it is pre-lithiated) comprising:
a first porous anode layer comprising a first porous anode active-material layer disposed on a first porous anode current-collector layer, wherein the first porous anode current-collector layer has an anode-current-collector porosity from about 5% to about 15%, and/or wherein the first porous anode current-collector layer has an average anode-current-collector pore size from about 1 micron to about 20 microns;
a first porous cathode layer comprising a first porous cathode active-material layer disposed on a first porous cathode current-collector layer, wherein the first porous cathode current-collector layer has a cathode-current-collector porosity from about 5% to about 15%, and/or wherein the first porous cathode current collector layer has an average cathode-current-collector pore size from about 1 micron to about 20 microns;
a first separator layer interposed between the first porous anode layer and the first porous cathode layer;
optionally, a first lithium-containing layer disposed in lithium-ion conduction but not in electron conduction with said first porous anode layer; and
optionally, an electrolyte,
wherein the first porous anode active-material layer contains lithium vanadium oxide LiₐV_{b}O_{c}, wherein a=1-10, b=1-3, c=1-9, and a, b, and c are selected to charge-balance the LiₐV_{b}O_{c}.

Some variations of the technology provide a lithium-ion battery (regardless how it is pre-lithiated) comprising:
a first porous anode layer comprising a first porous anode active-material layer disposed on a first porous anode current-collector layer, wherein the first porous anode current-collector layer has an anode-current-collector porosity from about 2% to about 12%, and/or wherein the first porous anode current-collector layer has an average anode-current-collector pore size from about 3 micron to about 20 microns;
a first porous cathode layer comprising a first porous cathode active-material layer disposed on a first porous cathode current-collector layer, wherein the first porous cathode current-collector layer has a cathode-current-collector porosity from about 2% to about 12%, and/or wherein the first porous cathode current collector layer has an average cathode-current-collector pore size from about 3 micron to about 20 microns;
a first separator layer interposed between the first porous anode layer and the first porous cathode layer;
optionally, a first lithium-containing layer disposed in lithium-ion conduction but not in electron conduction with said first porous anode layer; and
optionally, an electrolyte,
wherein the first porous anode active-material layer contains lithium vanadium oxide LiₐV_{b}O_{c}, wherein a=1-10, b=1-3, c=1-9, and a, b, and c are selected to charge-balance the LiₐV_{b}O_{c}.

In various embodiments of a lithium-ion battery, at least some of the LiₐV_{b}O_{c} has a disordered rocksalt structure in the Fm3̅m space group. In certain embodiments, all of the LiₐV_{b}O_{c} has a disordered rocksalt structure in the Fm3̅m space group.

In some embodiments of a lithium-ion battery, the first porous anode current-collector layer is a copper foil, a nickel foil, or a copper-nickel foil. In some embodiments, the first porous cathode current-collector layer is an aluminum foil.

The lithium-ion battery may contain multiple, repeating porous anode layers, porous cathode layers, and separator layers in various stacked and/or winded arrangements. The lithium-ion battery may employ a pouch-cell configuration, a coin-cell configuration, a cylindrical-cell configuration, a prismatic-cell configuration, or a configuration using an irregular cell shape, for example.

### Pre-Lithiation Using Liquid Lithium-Ion Conductor

Other variations of the invention provide a method of pre-lithiating an electrode material for a lithium-ion battery, the method comprising:
(a) providing an electrode precursor material having an initial degree of lithiation, wherein the electrode precursor material is in powder form;
(b) providing a lithium-containing layer disposed adjacent to the electrode precursor material, or configured in lithium mass transport with the electrode precursor material, wherein a Li transport path exists between the lithium-containing layer and the electrode precursor material;
(c) placing a liquid lithium-ion conductor into the Li transport path;
(d) reacting lithium, initially contained in the lithium-containing layer, with the electrode precursor material, using effective lithiation reaction conditions, thereby generating a lithiated electrode material; and
(e) recovering the lithiated electrode material, which may utilize washing, filtering or other separation, drying, thermal treatment at a temperature up to about 300° C., or a combination thereof.

In some embodiments, a dopant M is included in the electrode precursor in step (a) and/or in the lithium-containing layer in step (b). The dopant M may be selected from the group consisting of Na, K, Be, Mg, Ca, Zn, Fe, Co, Ni, Cu, Ag, Sc, B, Y, Al, La, Si, Ge, Sn, Ti, Zr, Mn, P, Nb, Ta, Cr, Mo, W, Se, N, S, F, Cl, Br, I, and combinations thereof, for example. The dopants may include one or more monovalent, divalent, trivalent, tetravalent, pentavalent, or hexavalent dopants. Multiple dopants may be present.

A dopant M may be introduced into the electrode precursor or lithium-containing layer through various methods depending on the desired properties and the type of dopant selected. Common dopants include transition metals (e.g., Ti, Cr, Mn, Fe, Co, Ni, or Cu), alkali or alkaline earth metals (e.g., Na, Mg, or Ca), and non-metals (e.g., P, N, or F). These dopants are typically used to enhance the electronic conductivity, improve the Li ion diffusivity, lower the operation potential, stabilize the crystal structure, or improve the electrochemical performance for energy-storage applications.

Dopants may be introduced during electrode-precursor preparation. For example, dopants such as Mg or Na may be added to a vanadium precursor solution (e.g., ammonium metavanadate or vanadium oxytrichloride) in the form of magnesium nitrate, sodium hydroxide, or corresponding salts. This method ensures uniform mixing of the dopant ions at the atomic level before the synthesis process, forming doped V₂O₅ upon thermal decomposition.

Dopants may be introduced during thermal treatment/annealing of the electrode precursor. For example, transition metals such as Cr, Mn, or Ni may be added in the form of oxides (e.g., Cr₂O₃, MnO₂, or NiO) or metal salts (e.g., nitrates or acetates). These materials may be mechanically mixed with V₂O₅ powder and annealed at specific temperatures (e.g., 300-500° C.) to promote diffusion of the dopant ions into the V₂O₅ lattice.

Dopants may be introduced via post-synthesis doping of the electrode precursor. Non-metals such as P, N, or F may be introduced into V₂O₅ through chemical treatments. For example, phosphorous can be incorporated via phosphoric acid vapor treatment, while nitrogen doping can be achieved through annealing in an ammonia (NH₃) atmosphere. Fluorine can be introduced by exposing the V₂O₅ material to fluorinated precursors or gaseous fluorine sources.

Each doping method and dopant selection allows for the tuning of V₂O₅ (and, when lithiated, LiₐV_{b}O_{c}) properties such as improved electronic conductivity, higher ion diffusivity, reduced working potential, and enhanced cycling stability, making the material more suitable for applications in lithium ion batteries, supercapacitors, and catalytic processes.

In some embodiments, the lithiated electrode material is a lithiated anode material. The lithiated anode material may be selected from the group consisting of lithiated vanadium oxide, lithiated silicon, lithiated silicon oxide, lithiated silicon/C, lithiated graphite, lithiated carbon, lithiated hard carbon, lithiated soft carbon, lithiated aluminum, lithiated magnesium, lithiated zinc, lithiated tin, lithiated tin oxide, lithiated phosphorus, and combinations thereof.

In some embodiments, the electrode precursor material (e.g., an anode precursor material) contains vanadium oxide and/or lithium vanadium oxide, wherein the lithiated anode material contains lithium vanadium oxide LiₐV_{b}O_{c}, and wherein a=1-10, b=1-3, c=1-9, and a, b, and c are selected to charge-balance the LiₐV_{b}O_{c}. In certain embodiments, at least some of the LiₐV_{b}O_{c} has a disordered rocksalt structure in the Fm3̅m space group.

In some embodiments, the lithiated electrode material is a lithiated cathode material. The lithiated cathode material may be selected from the group consisting of lithiated sulfur, lithiated sulfurized polyacrylonitrile, lithiated ferric fluoride, lithiated metal fluoride, lithiated metal sulfide, lithiated lithium nickel manganese cobalt oxide (LiNiₓCo_{y}Mn_{z}O₂ (x+y+z=1)), lithiated lithium nickel manganese oxide (LiNiₓMn_{z}O₂ (x+z=1)), lithiated lithium nickel cobalt oxide (LiNiₓCo_{y}O₂ (x+y=1)), lithiated lithium nickel cobalt aluminum oxide (LiNiₓCo_{y}Al_{z}O₂ (x+y+z=1)), lithiated lithium cobalt oxide (LiCoO₂), lithiated lithium nickel manganese spinel oxide (LiMnₓNi_{y}O₄ (x+y=2)), lithiated lithium manganese spinel oxide (LiMn₂O₄), lithiated lithium iron phosphate (LiFePO₄), lithiated lithium iron manganese phosphate (LiFeₓMn_{y}PO₄ (x+y=1)), lithiated lithium manganese spinel oxide (Li₂MnO₃), lithiated lithium-rich manganese-rich layered oxide (aLiNiₓCo_{y}Mn_{z}O₂·(1−a)Li₂MnO₃ (0<a<1 and x+y+z=1)), LiF, Li₂S, Li₂O, Li₂O₂, and combinations thereof.

In some embodiments, the initial degree of lithiation is 0 prior to step (d). In other embodiments, wherein the initial degree of lithiation is greater than 0 prior to step (d).

In some embodiments, the lithium-containing layer is in the form of a foil, an ingot, a powder, a wire, or a combination thereof.

In some embodiments, the liquid lithium-ion conductor is prepared by dissolving one or more lithium-containing salts into a non-aqueous solvent. The lithium-containing salts may be selected from the group consisting of LiPF₆, LiClO₄, LiBF₄, LiAsF₆, lithium bis(trifluoromethanesulfonyl)imide, lithium bis(fluorosulfonyl)imide, and combinations thereof, for example. The non-aqueous solvent may be selected from the group consisting of carbonates, ethers, esters, alcohols, ionic liquid, and combinations thereof, for example.

In some embodiments, the effective lithiation reaction conditions include a lithiation temperature selected from about −40° C. to about 200° C.

In some embodiments, the effective lithiation reaction conditions include a lithiation reaction time selected from about 0.1 hr to about 168 hr.

In some embodiments, the effective lithiation reaction conditions include a lithiation pressure selected from about 0.01 MPa to about 10 MPa.

In some embodiments, the effective lithiation reaction conditions include a lithiation pH selected from about 5 to about 14.

In some embodiments, the effective lithiation reaction conditions include a reaction atmosphere of an inert gas, such as Ar, He, and/or N₂. In some embodiments, the effective lithiation reaction conditions include a reaction atmosphere of dry air. Other atmospheres may be used for the lithiation reaction in step (d).

In some embodiments, lithium reaction with the electrode precursor material in step (d) is promoted by the presence of an electron conductor, an ion conductor, an electron-ion conductor, or a combination thereof, disposed on, or within, the electrode precursor material.

The electron-ion conductor may contain carbon, for example. The carbon may be selected from the group consisting of amorphous carbon, carbon nanotubes, carbon black, vapor-growth carbon fiber, ultra-fine carbon, graphene, graphite, hard carbon, soft carbon, non-graphitized carbon, ultrafine carbon, activated carbon, nanodiamonds, and combinations thereof. The carbon may be in sp form, sp² form, and/or sp³ form.

### Pre-Lithiation by Mechanically Agitating With Solid Lithium-Containing Material

Still other variations of the invention provide a method of pre-lithiating an electrode material for a lithium-ion battery, the method comprising:
(a) providing an electrode precursor material having an initial degree of lithiation, wherein the electrode precursor material is in powder form;
(b) providing a solid lithium-containing material;
(c) blending and mechanically agitating the electrode precursor material and the solid lithium-containing material;
(d) simultaneously with step (c), or sequentially after step (c), reacting lithium, initially contained in the solid lithium-containing material, with the electrode precursor material, using effective lithiation reaction conditions, thereby generating a lithiated electrode material; and
(e) recovering the lithiated electrode material, which may utilize washing, filtering or other separation, drying, thermal treatment at a temperature up to about 300° C., or a combination thereof.

In some embodiments, a dopant M is included in the electrode precursor in step (a). The dopant M may be selected from the group consisting of Na, K, Be, Mg, Ca, Zn, Fe, Co, Ni, Cu, Ag, Sc, B, Y, Al, La, Si, Ge, Sn, Ti, Zr, Mn, P, Nb, Ta, Cr, Mo, W, Se, N, S, F, Cl, Br, I, and combinations thereof, for example. The dopants may include one or more monovalent, divalent, trivalent, tetravalent, pentavalent, or hexavalent dopants. Multiple dopants may be present.

A dopant M may be introduced into the electrode precursor through various methods depending on the desired properties and the type of dopant selected. Common dopants include transition metals (e.g., Ti, Cr, Mn, Fe, Co, Ni, or Cu), alkali or alkaline earth metals (e.g., Na, Mg, or Ca), and non-metals (e.g., P, N, or F). These dopants are typically used to enhance the electronic conductivity, improve the Li ion diffusivity, lower the operation potential, stabilize the crystal structure, or improve the electrochemical performance for energy-storage applications.

Dopants may be introduced during electrode-precursor preparation. For example, dopants such as Mg or Na may be added to a vanadium precursor solution (e.g., ammonium metavanadate or vanadium oxytrichloride) in the form of magnesium nitrate, sodium hydroxide, or corresponding salts. This method ensures uniform mixing of the dopant ions at the atomic level before the synthesis process, forming doped V₂O₅ upon thermal decomposition.

Dopants may be introduced during thermal treatment/annealing of the electrode precursor. For example, transition metals such as Cr, Mn, or Ni may be added in the form of oxides (e.g., Cr₂O₃, MnO₂, or NiO) or metal salts (e.g., nitrates or acetates). These materials may be mechanically mixed with V₂O₅ powder and annealed at specific temperatures (e.g., 300-500° C.) to promote diffusion of the dopant ions into the V₂O₅ lattice.

Dopants may be introduced via post-synthesis doping of the electrode precursor. Non-metals such as P, N, or F may be introduced into V₂O₅ through chemical treatments. For example, phosphorous can be incorporated via phosphoric acid vapor treatment, while nitrogen doping can be achieved through annealing in an ammonia (NH₃) atmosphere. Fluorine can be introduced by exposing the V₂O₅ material to fluorinated precursors or gaseous fluorine sources.

Each doping method and dopant selection allows for the tuning of V₂O₅ (and, when lithiated, LiₐV_{b}O_{c}) properties such as improved electronic conductivity, higher ion diffusivity, reduced working potential, and enhanced cycling stability, making the material more suitable for applications in lithium ion batteries, supercapacitors, and catalytic processes.

In some embodiments, the lithiated electrode material is a lithiated anode material. The lithiated anode material may be selected from the group consisting of lithiated vanadium oxide, lithiated silicon, lithiated silicon oxide, lithiated silicon/C, lithiated graphite, lithiated carbon, lithiated hard carbon, lithiated soft carbon, lithiated aluminum, lithiated magnesium, lithiated zinc, lithiated tin, lithiated tin oxide, lithiated phosphorus, and combinations thereof.

In some embodiments, the electrode precursor material (e.g., anode precursor material) contains vanadium oxide and/or lithium vanadium oxide, wherein the lithiated anode material contains lithium vanadium oxide LiₐV_{b}O_{c}, and wherein a=1-10, b=1-3, c=1-9, and a, b, and c are selected to charge-balance the LiₐV_{b}O_{c}. In certain embodiments, at least some of the LiₐV_{b}O_{c} has a disordered rocksalt structure in the Fm3̅m space group.

In some embodiments, the lithiated electrode material is a lithiated cathode material. The lithiated cathode material may be selected from the group consisting of lithiated sulfur, lithiated sulfurized polyacrylonitrile, lithiated ferric fluoride, lithiated metal fluoride, lithiated metal sulfide, lithiated lithium nickel manganese cobalt oxide (LiNiₓCo_{y}Mn_{z}O₂ (x+y+z=1)), lithiated lithium nickel manganese oxide (LiNiₓMn_{z}O₂ (x+z=1)), lithiated lithium nickel cobalt oxide (LiNiₓCo_{y}O₂ (x+y=1)), lithiated lithium nickel cobalt aluminum oxide (LiNiₓCo_{y}Al_{z}O₂ (x+y+z=1)), lithiated lithium cobalt oxide (LiCoO₂), lithiated lithium nickel manganese spinel oxide (LiMnₓNi_{y}O₄ (x +y=2)), lithiated lithium manganese spinel oxide (LiMn₂O₄), lithiated lithium iron phosphate (LiFePO₄), lithiated lithium iron manganese phosphate (LiFeₓMn_{y}PO₄ (x+y=1)), lithiated lithium manganese spinel oxide (Li₂MnO₃), lithiated lithium-rich manganese-rich layered oxide (aLiNiₓCo_{y}Mn_{z}O₂·(1−a)Li₂MnO₃ (0<a<1 and x+y+z=1)), LiF, Li₂S, Li₂O, Li₂O₂, and combinations thereof.

In some embodiments, the initial degree of lithiation is 0 prior to step (d). In other embodiments, the initial degree of lithiation is greater than 0 prior to step (d).

In some embodiments, the lithium-containing layer is in the form of a foil, an ingot, a powder, a wire, or a combination thereof.

In some embodiments, the solid lithium-containing material is pure lithium. In other embodiments, the solid lithium-containing material is a lithium compound. The lithium compound may be a lithium-ion conductor, such as a lithium-ion conductor selected from the group consisting of oxides, sulfides, phosphates, argyrodites, β-aluminas, LISICON, garnets, NASICON, perovskites, antiperovskites, lithium nitrides, lithium hydrides, LiAlH₄, LiBH₄, lithium phosphidotrielates and phosphidotetrelates, lithium metal halides, LIPON, lithium thiophosphates, and combinations thereof.

In some embodiments, the solid lithium-containing material is a powder with an average particle size selected from about 0.01 microns to about 20 microns.

In some embodiments, the electrode precursor material has an average particle size selected from about 0.05 microns to about 20 microns.

In some embodiments, after step (c), the mechanically agitated material consisting of the electrode precursor material and the solid lithium-containing material has an average particle size selected from about 0.05 microns to about 20 microns.

In some embodiments, step (c) employs ball milling to blend and mechanically agitate the electrode precursor material and the solid lithium-containing material. Other types of milling may be employed, such as (but not limited to) bead milling and roll jar milling.

In some embodiments, the effective lithiation reaction conditions include a lithiation temperature selected from about −40° C. to about 200° C.

In some embodiments, the effective lithiation reaction conditions include a lithiation pressure selected from about 0.01 MPa to about 10 MPa.

In some embodiments, the effective lithiation reaction conditions include a lithiation reaction time selected from about 0.1 hr to about 168 hr.

In some embodiments, the effective lithiation reaction conditions include a reaction atmosphere of an inert gas, such as Ar, He, and/or N₂. In some embodiments, the effective lithiation reaction conditions include a reaction atmosphere of dry air. Other atmospheres may be used for the lithiation reaction in step (d).

In some embodiments, lithium reaction with the electrode precursor material in step (d) is promoted by the presence of an electron conductor, an ion conductor, an electron-ion conductor, or a combination thereof, disposed on, or within, the electrode precursor material. Alternatively, or additionally, lithium reaction with the electrode precursor material in step (d) may be promoted by the presence of an electron conductor, an ion conductor, an electron-ion conductor, or a combination thereof, disposed on, or within, the solid lithium-containing material.

An electron-ion conductor is a material that conducts both electrons and ions. The electron-ion conductor may contain carbon, which may be in sp form, sp² form, and/or sp³ form. The carbon may be selected from the group consisting of amorphous carbon, carbon nanotubes, carbon black, vapor-growth carbon fiber, ultra-fine carbon, graphene, graphite, hard carbon, soft carbon, non-graphitized carbon, ultrafine carbon, activated carbon, nanodiamonds, and combinations thereof.

### General Features and Options for Various Embodiments

Various features and options will now be further described, as pertaining to some embodiments of the technology, such as those embodiments utilizing lithium vanadium oxide.

In some embodiments, about 0.01 wt % to 100 wt % of the LiₐV_{b}O_{c} has a disordered rocksalt structure in the Fm3̅m space group. Preferably, at least 10 wt % of the LiₐV_{b}O_{c} has a disordered rocksalt structure in the Fm3̅m space group. More preferably, at least 50 wt % of the LiₐV_{b}O_{c} has a disordered rocksalt structure in the Fm3̅m space group. Even more preferably, at least 90 wt % of the LiₐV_{b}O_{c} has a disordered rocksalt structure in the Fm3̅m space group. Most preferably, essentially all of the LiₐV_{b}O_{c} has a disordered rocksalt structure in the Fm3̅m space group. In various embodiments, at least 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, 91 wt %, 92 wt %, 93 wt %, 94 wt %, 95 wt %, 96 wt %, 97 wt %, 98 wt %, 99 wt %, 99.5 wt %, or 99.9 wt % (such as 100 wt %) of the LiₐV_{b}O_{c} has a disordered rocksalt structure in the Fm3̅m space group.

A disordered rocksalt structure is described by Liu et al., “A disordered rock salt anode for fast-charging lithium-ion batteries”, Nature volume 585, pages 63-67 (2020), which is hereby incorporated by reference. The disordered rocksalt crystal structure can be indexed in the Fm3̅m space group, with a cubic lattice parameter a=4.095 Å. The disordered rocksalt crystal structure of LiₐV_{b}O_{c} is a crystal lattice containing a disordered (rather than strictly periodic) arrangement of lithium (Li) and transition metal (V) on the cation lattice. The oxygen atoms are close packed to form the face-centered-cubic structure. The majority of the lithium (Li) and transition metal (V) locate at octahedral sites formed by oxygen. Lithium (Li) can be also distributed in tetrahedral sites formed by oxygen.

A disordered rocksalt crystal structure contrasts with an ordered rocksalt crystal structure, such as with NaCl, in which the sodium and chloride ions form regular, orderly structures. In a disordered rocksalt crystal structure, the precise sites for the metal ions vary, but there is still an overall crystal structure. This specification hereby incorporates by reference International Tables for Crystallography Volume A: Space-group symmetry, Second online edition, edited by Aroyo, 2016.

A disordered rocksalt crystal structure also contrasts with an disordered amorphous structure that lacks a crystalline lattice. For example, when LiₐV_{b}O_{c} is nominally Li₃V₂O₅, an amorphous structure would mean that the Li, V, and O atoms are randomly placed in the material, randomly bonded with each other, and do not form a crystal. Crystalline solids have well-defined edges and faces, diffract X-rays, and tend to have sharp melting points. In contrast, amorphous solids have irregular or curved surfaces, do not give well-resolved X-ray diffraction patterns, and melt over a wide range of temperatures. In this invention, the LiₐV_{b}O_{c} is preferably crystalline, or has a crystallinity of at least 80%, at least 85%, at least 90%, at least 95%, at least 99%, or 100%. LiₐV_{b}O_{c} with a crystallinity of at least 80% is referred to herein as crystalline LVO, or c-LVO. LVO crystallinity may be measured using X-ray diffraction.

A LiₐV_{b}O_{c} precursor that does not contain any lithium—typically, vanadium pentoxide, V₂O₅—may itself be crystalline or amorphous. In principle, a disordered rocksalt structure does not become possible until there is at least one lithium atom inserted into V₂O₅ (i.e., a>0 in LiₐV_{b}O_{c}). During lithiation, as the value of a increases, the rocksalt structure is preferably maintained, even to very high values of a, such as 4, 5, or even greater. For example, in preferred embodiments, the disordered rocksalt structure is maintained through conversion of Li₃V₂O₅ to Li₄V₂O₅ or Li₅V₂O₅. During lithiation, following the initial formation of a disordered rocksalt structure upon the introduction of lithium atoms, there may be a further increase in the fraction of the LiₐV_{b}O_{c} that has a disordered rocksalt crystal structure. In other embodiments, the fraction of the LiₐV_{b}O_{c} that has a disordered rocksalt crystal structure stays relatively constant as the degree of lithiation (the value of a) increases. In certain embodiments, at the first discharge, the LiₐV_{b}O_{c} may exhibit a superstructure of the rocksalt lattice which disappears upon further cycling. The disappearance of the superstructure does not affect the disordered rocksalt structure and electrochemical performance.

The LiₐV_{b}O_{c} may be present in a non-lithiated state, wherein a=0 in the LiₐV_{b}O_{c}. During use of the anode material, and potentially prior to use of the anode material, the LiₐV_{b}O_{c} is present in a lithiated state, wherein a>0 in the LiₐV_{b}O_{c}.

In some embodiments, the LiₐV_{b}O_{c} is selected from the group consisting of Li₃V₂O₅, Li₄V₂O₅, Li₅V₂O₅, LiV₂O₅, Li_{0.001}V₂O₅, Li₂V₂O₅, Li_{0.001}VO₂, LiVO₂, Li₂VO₂, Li_{0.001}VO₃, LiVO₃, Li₂VO₃, Li₃VO₃, Li_{0.001}V₃O₈, LiV₃O₈, Li₂V₃O₈, Li₃V₃O₈, Li_{0.001}V₂O₃, LiV₂O₃, Li₂V₂O₃, Li₃V₂O₃, and combinations thereof.

The LiₐV_{b}O_{c} may have a density of about 1.5 g/cm³ to about 5.5 g/cm³. In various embodiments, the LiₐV_{b}O_{c} has a density of about, at least about, or at most about 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.35, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, or 5.5 g/cm³, including any intervening ranges.

In some embodiments, the lithium vanadium oxide further contains a dopant M that is chemically or physically contained within the lithium vanadium oxide such that its composition is given by LiₐV_{b}O_{c}M_{d}, wherein a=0.001-10, b=1-3, c=1-9, and d=0.001-3, wherein a, b, c, and d are selected to charge-balance the LiₐV_{b}O_{c}M_{d}, and wherein the LiₐV_{b}O_{c}M_{d} is capable of being reversibly lithiated. The formula LiₐV_{b}O_{c}M_{d} is a stoichiometric convenience and does not necessarily mean that the dopant M is chemically bonded with any other species present.

The dopant M may be selected from the group consisting of Na, K, Be, Mg, Ca, Zn, Fe, Co, Ni, Cu, Ag, Sc, B, Y, Al, La, Si, Ge, Sn, Ti, Zr, Mn, P, Nb, Ta, Cr, Mo, W, Se, N, S, F, Cl, Br, I, and combinations thereof, for example. The dopants may include one or more monovalent, divalent, trivalent, tetravalent, pentavalent, or hexavalent dopants. Multiple dopants may be present in LiₐV_{b}O_{c}M_{d}, in which case each dopant in the empirical formula may have d=0.1-3.

Dopants may be used to modify the properties of the lithium vanadium oxide. For example, dopants may be used to adjust lithiation, delithiation, or other kinetics; lithiation capacity; anode stability; lithiation-delithiation potential; anode material electronic conductivity; lithium-ion diffusivity in anode material crystal structures; thermal properties; densities; and/or other factors.

The doped composition may have a disordered rocksalt structure. The disordered rocksalt crystal lattice may or may not incorporate the dopant elements. That is, when there is a dopant M, in some embodiments, the disordered rocksalt crystal structure of LiₐV_{b}O_{c}M_{d} is a crystal lattice containing a disordered arrangement of Li atoms, V atoms, and M atoms on the cation lattice site. Alternatively, or additionally, the dopant M may be in a different position than within the cation lattice of the disordered rocksalt crystal structure, such as randomly placed, or in a different crystalline lattice governing the relationship of M with other atoms, potentially superimposed on the disordered rocksalt crystal structure. In certain embodiments, the presence of a dopant M reduces the optimal amount of vanadium (the value of b) in the disordered rocksalt anode material. In certain embodiments, dopant M atoms replace lithium Li atoms. In other certain embodiments, the presence of a non-metal dopant M (e.g., M=N, S, F, Cl, Br, or I) reduces the optimal amount of oxygen (the value of c) in the disordered rocksalt anode material.

In preferred embodiments using a dopant, at least some of the LiₐV_{b}O_{c}M_{d} has a disordered rocksalt structure in the Fm3̅m space group. About 0.01 wt % to 100 wt % of the LiₐV_{b}O_{c}M_{d} may have a disordered rocksalt structure in the Fm3̅m space group.

The LiₐV_{b}O_{c}M_{d} (doped anode material) may have a density of about 1.5 g/cm³ to about 4.5 g/cm³. Preferably, at least 50 wt % or at least 90 wt % of the LiₐV_{b}O_{c}M_{d} has a disordered rocksalt structure in the Fm3̅m space group. In various embodiments, at least 50 wt %, 60 wt %, 70 wt %, 80 wt %, 90 wt %, 95 wt %, or 99 wt % (such as 100 wt %) of the LiₐV_{b}O_{c}M_{d} has a disordered rocksalt structure in the Fm3̅m space group.

In some embodiments, the anode-material particles have a shape selected from the group consisting of spherical, columnar, cubic, irregular, and combinations thereof. The anode-material particles may have an average effective diameter selected from about 0.01 microns to about 100 microns, for example. In various embodiments, the average effective diameter of the anode-material particles is about, at least about, or at most about 0.01, 0.05, 0.1, 0.2, 0.3, 0.4, 0.5, 1, 1.5, 2, 2.5, 3, 4, 5, 10, 15, 20, 25, 30, 40, 50, 60, 70, 80, 90, or 100 microns, including any intervening ranges. The anode-material particles may have a unimodal or a multimodal size distribution.

Particle sizes may be measured by a variety of techniques, including dynamic light scattering, laser diffraction, or image analysis, for example. Dynamic light scattering is a non-invasive, well-established technique for measuring the size and size distribution of particles typically in the submicron region, and with the latest technology down to 1 nanometer. Laser diffraction is a widely used particle-sizing technique for materials ranging from hundreds of nanometers up to several millimeters in size. Exemplary dynamic light scattering instruments and laser diffraction instruments for measuring particle sizes are available from Malvern Instruments Ltd., Worcestershire, UK. Image analysis to estimate particle sizes and distributions can be done directly on photomicrographs, scanning electron micrographs, or other images.

The anode layer may further contain an anode carbon additive in sp form, sp² form, and/or sp³ form. The anode carbon additive may be graphite, graphene, carbon nanotubes, carbon fibers (e.g., vapor-grown carbon fiber), non-graphitized carbon, ultrafine carbon, activated carbon, carbon black, nanodiamonds, hard carbon, soft carbon, or a combination thereof.

In some embodiments, the anode material is characterized in that it is chemically stable in the presence of air. In this disclosure, chemical stability in the presence of air is determined at atmospheric pressure (1 bar) and room temperature (25° C.) for at least 1 day, preferably at least 1 week, and more preferably at least 1 month.

In some embodiments, the anode material is characterized in that it is chemically stable in the presence of water. In this disclosure, chemical stability in the presence of water is determined at atmospheric pressure (1 bar) and room temperature (25° C.), in a water soak, for at least 1 hour, preferably at least 2 hours, and more preferably at least 3 hours.

In some embodiments, the anode further contains one or more binders. Binders may hold active anode material together as well as place the active anode material in contact with the anode substrate (e.g., copper foil). The binders may also help keep conductive carbon additives in place against the active material.

The binders may be aqueous-based binders selected from the group consisting of carboxymethyl cellulose, styrene-butadiene rubber, styrene-butadiene copolymer, polyacrylic acid, lithium-substituted polyacrylic acid, and combinations thereof, for example. Alternatively, or additionally, the binders may be non-aqueous-based binders selected from the group consisting of polyvinylidene fluoride, poly(vinylidenefluoride-co-hexafluoropropylene), polytetrafluoroethylene, and combinations thereof, for example.

The binders may range in concentration from about 0 wt % to about 50 wt % of the anode, for example. In various embodiments, the binders collectively have a total concentration of about, at least about, or at most about 0 wt %, 0.25 wt %, 0.5 wt %, 1 wt %, 2 wt %, 5 wt %, 10 wt %, 15 wt %, 20 wt %, 25 wt %, 30 wt %, 40 wt %, 50 wt %, 60 wt %, 70 wt %, or 80 wt %, including any intervening ranges.

In some embodiments, the anode has a volumetric anode porosity selected from about 5% to about 80%. In various embodiments, the anode has a volumetric anode porosity of about, at least about, or at most about 5%, 10%, 15%, 20%, 25%, 30%, 40%, 50%, 60%, 70%, or 80%, including any intervening ranges.

In some embodiments, the anode has an average anode thickness from about 100 nanometers to about 500 microns. In various embodiments, the anode has an average anode thickness of about, at least about, or at most about 100 nm, 200 nm, 300 nm, 400 nm, 500 nm, 1 μm, 2 μm, 5 μm, 10 μm, 15 μm, 20 μm, 25 μm, 30 μm, 40 μm, 50 μm, 60 μm, 70 μm, 80 μm, 90 μm, 100 μm, 200 μm, 300 μm, 400 μm, or 500 μm, including any intervening ranges.

The anode layer may contain silicon as well as the lithium vanadium oxide LiₐV_{b}O_{c}. For example, the anode layer may have a composition disclosed in WO 2022/178246 A1, published on Aug. 25, 2022, which is incorporated by reference. Some variations utilize an anode material comprising: (a) a porous anode phase comprising silicon, wherein the porous phase is characterized by a porous-phase volumetric porosity that is selected from about 5% to about 80%; and (b) a first solid-state mediator layer outwardly disposed on the porous anode phase, wherein the first solid-state mediator layer contains a lithium vanadium oxide material, wherein the lithium vanadium oxide material has a density of about 2.0 g/cm³ to about 4.5 g/cm³, wherein the lithium vanadium oxide material has a composition given by LiₐV_{b}O_{c}, wherein a=0-10, b=1-3, c=1-9, and a, b, and c are selected to charge-balance the LiₐV_{b}O_{c}, and wherein the LiₐV_{b}O_{c} is capable of being reversibly lithiated. In some embodiments, the anode material is a core-shell material in which the first solid-state mediator layer forms a shell that encapsulates the porous anode phase. In some embodiments, the anode material is a sandwiched material in which the first solid-state mediator layer is outwardly disposed on a first side of the porous anode phase, wherein a second solid-state mediator layer is outwardly disposed on a second side of the porous anode phase, and wherein the second solid-state mediator layer contains the lithium vanadium oxide material. The silicon may be present in the porous anode phase in a concentration from about 1 wt % to 100 wt % Si. The silicon may be amorphous silicon, polycrystalline silicon, or single-crystalline silicon. The silicon may have an average particle size from about 10 nanometers to about 100 microns, for example. The silicon may be present as particles with a particle geometry selected from the group consisting of spheres, columns, cubes, cylinders, tubes, wires, sheets, fibers, irregular shapes, and combinations thereof, for example.

The anode may be present in a cell. A “cell” is an electrochemical cell that is capable of either generating electrical energy from chemical reactions or using electrical energy to cause chemical reactions.

The cell may further comprise a cathode, an electrolyte layer, and a packet foil surrounding the anode, the electrolyte layer, and the cathode, wherein the electrolyte layer electrically separates the anode from the cathode. The anode composite may be disposed on a first substrate (e.g., copper foil) to form an anode, and the cathode composite may be disposed on a second substrate (e.g., aluminum foil) to form a cathode. There may be multiple layers of anode, electrolyte layer, and cathode, in a layered cell configuration. The layers may be repeatedly stacked to form multi-layer stackings in a cell configuration, forming anode, electrolyte layer, cathode, electrolyte layer, anode, electrolyte layer, cathode, electrolyte layer . . . and so on, depending on total number of layers.

The packet foil insulates the anode-electrolyte layer-cathode assembly from the external environment. The packet foil may be fabricated from polymers, such as polyamide, polyester-polyurethane, polypropylene, and/or metals, such as aluminum. The thickness of the packet foil may range from about 20 μm to about 200 μm.

In some embodiments, the anode has an anode material loading selected from about 20 wt % to about 100 wt %, such as about 20 wt %, 30 wt %, 40 wt %, 50 wt %, 60 wt %, 70 wt %, 80 wt %, 90 wt %, or 100 wt %, including any intervening ranges.

In some embodiments, the anode has an anode material areal loading selected from about 0.2 mg/cm² to about 50 mg/cm² on at least one side of the anode, such as about 0.2, 0.5, 1, 2, 5, 10, 15, 20, 25, 30, 35, 40, 45, or 50 mg/cm², including any intervening ranges, on at least one side of the anode (e.g., on both sides of the anode).

In some embodiments, the anode has an anode material areal capacity selected from about 0.05 mA·h/cm² to about 10 mA·h/cm² on at least one side of the anode, such as about 0.05, 0.1, 0.2, 0.5, 1, 2, 3, 4, 5, 6, 7, 8, 9, or 10 mA·h/cm², including any intervening ranges, on at least one side of the anode (e.g., on both sides of the anode).

In some embodiments, the anode has a capacity ranging from about 50 mA·h/g to about 2000 mA·h/g, such as about 50, 100, 150, 200, 250, 300, 350, 400, 450, 500, 600, 700, 800, 900, 1000, 1100, 1200, 1300, 1400, 1500, 1600, 1700, 1800, 1900, or 2000 mA·h/g, including any intervening ranges.

In some embodiments, the anode has a negative to positive electrode ratio (N/P ratio) ranging from about 0.5 to about 2, such as about 0.5, 0.6, 0.7, 0.8, 0.9, 1.0, 1.1, 1.2, 1.3, 1.4, 1.5, 1.6, 1.7, 1.8, 1.9, or 2.0, including any intervening ranges.

A copper foil, or other metal foil, may be used as a substrate upon which to place the anode material. In some embodiments, the copper foil thickness may range from about 1 μm to about 100 μm, such as about 1, 5, 10, 20, 30, 40, or 50 μm, including any intervening ranges. In some embodiments, the anode press density may range from about 0.3 g/cm³ to about 5 g/cm³, such as about 0.3, 0.4, 0.5, 1, 1.5, 2, 2.5, 3, 3.5, 4, 4.5, or 5 g/cm³, including any intervening ranges.

When the anode material is disposed on a substrate, typically the anode material is disposed on both sides of a substrate layer. This is referred to as a double layer. Within a cell, the number of double layers may vary widely, such as from 1 to about 50, e.g. about 1, 2, 3, 4, 5, 10, 15, 20, 25, 30, 35, 40, 45, 50, or more.

The anode material may be able to facilitate Li-ion battery charging on the scale of minutes without a complicated nanosizing process. The anode material may enable a fast charge battery without sacrificing energy density. In some embodiments, the anode material may show a voltage plateau ranging from about 0 V to about 2 V. The range of the voltage potential may ensure that under high current, the anode potential achieves a value that does not cause lithium plating. The range of the voltage potential may also ensure that the average cell voltage does not decrease to less than about 1.5 V, when a common cathode material is used.

The cathode material may be selected from the group consisting of LiCoO₂, LiMn₂O₄, Li₂MnO₃, LiFePO₄, LiNiₓCo_{y}Al_{z}O₂ (x+y+z=1), LiMnₓNi_{y}O₄ (x+y=2), LiNiₓCo_{y}Mn_{z}O₂ (x+y+z=1), LiFeₓMn_{y}PO₄ (x+y=1), aLiNiₓCo_{y}Mn_{z}O₂·(1−a)Li₂Mn₃ (0<a<1 and x+y+z=1), and combinations thereof, for example. In some embodiments, the cathode material is the LiNiₓCo_{y}Mn_{z}O₂. The LiNiₓCo_{y}Mn_{z}O₂ may be LiNi_{0.8}Co_{0.1}Mn_{0.1}O₂, for example. Other cathode materials may be utilized. The cathode may be paired with an anode based on each electrode's composition.

The cathode layer preferably further contains a cathode carbon additive in sp form, sp² form, and/or sp³ form. The cathode carbon additive may be graphite, graphene, carbon nanotubes, carbon fibers (e.g., vapor-grown carbon fiber), non-graphitized carbon, ultrafine carbon, activated carbon, carbon black, nanodiamonds, hard carbon, soft carbon, or a combination thereof. The cathode carbon additive may be the same type of carbon as the anode carbon additive, or they may be different types of carbon.

In some embodiments, the cathode may have a capacity ranging from about 50 mA·h/g to about 400 mA·h/g, for example. In some embodiments, the active cathode material loading may range from about 50 wt % to about 100 wt %. In some embodiments, the coating weight for each side of the cathode may range from about 0.5 mg/cm² to about 50 mg/cm². In some embodiments, the areal capacity for each side of the cathode may range from about 0.2 mA·h/cm² to about 10 mA·h/cm².

In some embodiments, the cathode press density may range from about 0.3 g/cm³ to about 5 g/cm³. Aluminum foil may be used as a substrate upon which to place the cathode material. In some embodiments, the aluminum foil thickness may range from about 1 μm to about 100 μm. The number of cathode double layers may range from 1 to about 50, for example.

Some embodiments employ a solid electrolyte. The solid electrolyte promotes the movement of ions between the cathode and the anode during charge and discharge. During charging, the lithium ions transport from cathode to anode; while discharging the lithium ions transport from anode to cathode.

In various embodiments, the solid electrolyte is selected from the group consisting of oxides, sulfides, phosphates, argyrodites, β-aluminas, LISICON, garnets, NASICON, perovskites, antiperovskites, lithium nitrides (e.g., lithium metal nitrides), lithium hydrides (e.g., lithium metal hydrides), lithium phosphidotrielates, lithium phosphidotetrelates, lithium halides (e.g., lithium chloride), lithium metal halides (e.g., lithium metal chlorides), LIPON, lithium thiophosphates, LiAlH₄, LiBH₄, and combinations thereof. Lithium metal chlorides, Li—M—Cl, may utilize a non-lithium metal M such as, but not limited to, Y, Tb, Lu, Sc, Er, In, or Zr. An exemplary lithium metal chloride is Li₂ZrCl₆. Another exemplary lithium metal chloride is Li₃YCl₃. Generally, in some embodiments, the solid electrolyte may be selected from lithium metal halides Li—M—X, where M=Y, Tb, Lu, Sc, Er, In, or Zr; and X=Cl, Br, I. In this specification, “lithium metal halide” refers to a material that has a metal other than lithium, in addition to lithium.

In some embodiments, solid electrolyte materials can be based on oxides, sulfides, or phosphates, and can have a variety of crystalline structures. Some examples of these structures include LISICON (lithium superionic conductor) (e.g., LGPS, LiSiPS, or LiPS); argyrodite-like structures (e.g. Li₆PS₅X, X=Cl, Br, I); garnets (e.g., LLZO, Li₇La₃Zr₂O₁₂); NASICON (sodium superionic conductor); lithium nitrides (e.g., Li₃N); lithium hydrides (e.g., LiBH₄); lithium phosphidotrielates or phosphidotetrelates; perovskites (e.g., lithium lanthanum titanate, LLTO); and lithium metal halides (e.g., Li₃YCl₆ or Li₃YBr₆). Additionally, some inorganic solid electrolytes can be in an amorphous state, resembling glass ceramics. Examples of these include lithium phosphorus oxynitride (LIPON) and lithium thiophosphates (Li₂S—P₂S₅).

In some embodiments, the solid electrolyte is a sulfur-based superionic conductor, such as a halogen-containing lithium argyrodite. The halogen-containing lithium argyrodite may be selected from Li_{6-ε}PS_{5—ε}X_{1+ε}, wherein −1<ε≤1, and wherein X=F, Cl, Br, I, or a combination thereof. For example, X may be Cl, and 0≤ε≤0.8. In some embodiments, the sulfur-based superionic conductor is selected from the group consisting of Li₂S—P₂S₅, Li₇P₃S₁₁, Li₁₀GeP₂S₁₂, Li₇SiPS₈, Li₃PS₄, Li₁₊₂ₓZn₁₋ₓPS₄ (0≤x<1), and combinations thereof.

In some embodiments, the solid electrolyte is an oxide-based superionic conductor. The oxide-based superionic conductor may be selected from the group consisting of Li—Al₂O₃, Li₇La₃Zr₂O₁₂, Li₂₊₂ₓZn₁₋ₓGeO₄ (0≤x≤1), Li₁₊ₓZr₂SiₓP₃₋ₓO₁₂ (0<x<3), La_{2/3-x}Li₃ₓTiO₃ (0<x<⅔), LiₓX¹₃X²₂O₁₂ (X¹=La, Nd, Mg, or Ba; X²=Te, Ta, Nb, Zr, or In; and 0<x<7), and combinations thereof.

In some embodiments, the solid electrolyte is a phosphate-based superionic conductor. The phosphate-based superionic conductor may be selected from the group consisting of Li₃PO₄, Li₁₊ₓX¹ₓX²₂₋ₓ(PO₄)₃ (X¹=Al, La, In, or Cr; X²=Ti, Ge, Zr, Hf, or Sn; and 0<x<2), and combinations thereof.

In some embodiments, the solid electrolyte is a nitride-based superionic conductor. The nitride-based superionic conductor may be selected from the group consisting of Li₃N, LiₓPO_{y}N_{z} (0<x≤3; 0<y≤4; and 0<z≤1), and combinations thereof.

In some embodiments, the solid electrolyte is a hydride-based superionic conductor. The hydride-based superionic conductor may be selected from the group consisting of LiBH₄, LiCB₉H₁₀, LiCB₁₁H₁₂, and combinations thereof.

In some embodiments, in which the solid electrolyte is selected from antiperovskites, the antiperovskites are selected from the group consisting of Li₃OCl, Li₃OBr, Li₃OF, Li₃OI, and combinations thereof.

In some embodiments, the solid electrolyte layer contains a mixed electrolyte, i.e., a mixture of two or more different types of solid electrolyte. In some embodiments, the solid electrolyte layer contains or consists of a few different layers with different solid electrolyte materials.

In some solid-state lithium-ion batteries, the solid electrolyte is also contained within the anode layer. In these or other embodiments, the solid electrolyte is also contained within the cathode layer. The anode layer and the cathode layer may incorporate different solid electrolytes.

In certain embodiments, the anode layer, the cathode layer, or the solid electrolyte layer further contains a noble metal in neutral or ionic form. The noble metal is typically present only in trace concentrations. The noble metal may be selected from the group consisting of Au, Ag, Pt, Rh, Pd, Ru, Os, Ir, and combinations thereof.

Typically, the cathode layer is disposed on a cathode current collector (e.g., Al foil), and the anode layer is disposed on an anode current collector (e.g., Cu foil).

In some embodiments, the lithium-ion battery contains a plurality of anode layers, a plurality of solid electrolyte layers, and a plurality of cathode layers.

In some embodiments, the lithium-ion battery is contained within a battery module/pack comprising a plurality of batteries. The battery module/pack may be contained within an electric vehicle. The electric vehicle may be an electric automobile, an electric truck, an electric bus, an electric locomotive, or an electric airplane, for example.

In some embodiments, the lithium-ion battery is contained within a portable device. In some embodiments, the lithium-ion battery is contained within a smart device. In some embodiments, the lithium-ion battery is contained within an emergency power backup system. In some embodiments, the lithium-ion battery is contained within an energy storage system. In some embodiments, the lithium-ion battery is contained within a solar-power electricity storage system.

The battery charge/discharge current may be expressed as a C-rate in order to normalize against battery capacity. A C-rate is a measure of the rate at which a battery is charged/discharged relative to its maximum capacity. A 1 C rate means that the charge/discharge current will charge/discharge the battery in 1 hour. For a battery with a capacity of 10 A·h (amp-hours), this equates to a charge/discharge current of 10 A (amps). A 20 C rate for this battery would be 200 A, and a C/2 rate would be 5 A.

In typical methods of use, a cell is repeatedly charged and discharged over multiple charge-discharge cycles, wherein the LiₐV_{b}O_{c} is reversibly lithiated and delithiated a plurality of times. The cell may be charged and discharged over at least 1000 cycles, for example. In various embodiments, the number of charge-discharge cycles is 1, 2, 3, 4, 5, 10, 20, 30, 40, 50, 60, 70, 80, 90, 100, 200, 300, 400, 500, 600, 700, 800, 900, 1000, 1100, 1200, 1500, 2000, 2500, 3000, 3500, 4000, 4500, or 5000, or even more, for example.

The battery system may be rechargeable in about, or less than about, 30, 25, 20, 15, 10, 9, 8, 7, 6, 5, 4, 3, 2, 1, 0.5, 0.2, or 0.1 minutes, in various embodiments.

In some embodiments, the presently disclosed technology may be used in a battery system that is superior to conventional graphite battery packs and which has a lower number of cells in the battery pack. The battery system is suitable for many commercial applications, including electric vehicles, smart devices, and high-power portable devices with high energy density.

One skilled in the battery art will appreciate that the principles of battery design, including calculations, modeling, simulations, and engineering may be carried out using the benefit of the present disclosure and the anode materials. One skilled in the battery art, with the benefit of this disclosure, will understand how to scale a battery cell larger or smaller for different battery applications.

In some embodiments of the invention, one or more individual components of a solid-state lithium-ion battery are produced and then sent to another party for incorporating into a cell. In some embodiments of the invention, a cell is produced and then sent to another party for incorporating into a final device or vehicle. In some embodiments of the invention, a cell is produced and then sent to another party for incorporating into a module. In some embodiments of the invention, a module is produced and then sent to another party for incorporating into a final device or vehicle. In some embodiments of the invention, a cell is produced and then sent to another party for incorporating into a pack. In some embodiments of the invention, a module is produced and then sent to another party for incorporating into a pack. In some embodiments of the invention, a pack is produced and then sent to another party for incorporating into a final device or vehicle.

In this detailed description, reference has been made to multiple embodiments and to the accompanying drawings in which are shown by way of illustration specific exemplary embodiments of the technology. These embodiments are described in sufficient detail to enable those skilled in the art to practice the technology, and it is to be understood that modifications to the various disclosed embodiments may be made by a skilled artisan.

Where methods and steps described above indicate certain events occurring in certain order, those of ordinary skill in the art will recognize that the ordering of certain steps may be modified and that such modifications are in accordance with the variations of the technology. Additionally, certain steps may be performed concurrently in a parallel process when possible, as well as performed sequentially.

All publications, patents, and patent applications cited in this specification are herein incorporated by reference in their entirety as if each publication, patent, or patent application were specifically and individually put forth herein. This disclosure hereby incorporates by reference U.S. Patent App. Pub. No. 2021/0184210 A1, published on Jun. 17, 2021. This disclosure also hereby incorporates by reference U.S. Patent App. Pub. No. 2023/0120748 A1, published on Apr. 20, 2023. This disclosure also hereby incorporates by reference U.S. Patent App. Pub. No. 2024/0113282 A1, published on Apr. 4, 2024.

The embodiments, variations, and figures described above should provide an indication of the utility and versatility of the present technology. Other embodiments that do not provide all of the features and advantages set forth herein may also be utilized, without departing from the spirit and scope of the technology. Such modifications and variations are considered to be within the scope of the technology defined by the claims.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. It will be apparent to one of skill in the art how alternative functional, logical, or physical partitioning and configurations can be implemented to implement the desired features of the technology disclosed herein. Additionally, with regard to flow diagrams, operational descriptions, and methods, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the disclosed technology, whether or not such features are presented as being a part of a described embodiment. Thus, the breadth and scope of the technology disclosed herein should not be limited by any of the above-described exemplary embodiments. As will become apparent to one of ordinary skill in the art after reading this patent application, the illustrated embodiments and their various alternatives can be implemented without confinement to the illustrated examples.

### EXAMPLES

### Example 1: Controlled Discharge Sequence for Pre-Lithiation

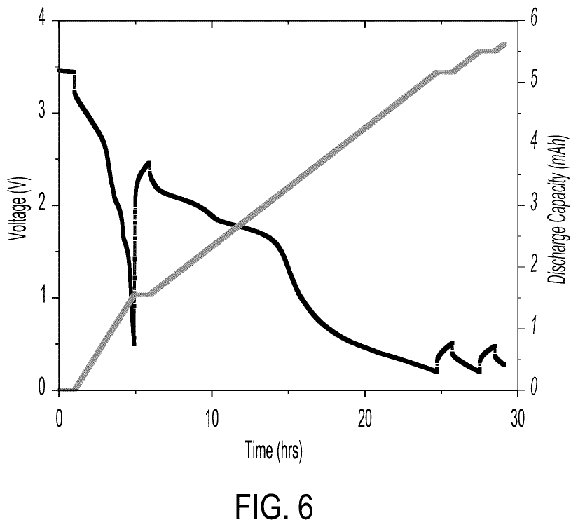

A coin cell is fabricated according to FIG. 1, and then tested for pre-lithiation of V₂O₅ electrode using a controlled discharge sequence employing a progressively decreasing current rate. The experimental data are shown in FIG. 6.

In this Example 1, the pre-lithiation protocol systematically partitions the discharge phase into multiple sequential steps, each characterized by a progressively decreased current rate. As shown in FIG. 6, an initial discharge current rate of 0.2 C was employed to discharge the coin cell with a cut off voltage of 0.5 V. Subsequently, the current rate was adjusted to 0.1 C, concurrently with a cutoff voltage adjustment to 0.2 V, to facilitate further discharge. Additionally, a 1-hour rest was introduced between each discharge cycle until the cumulative discharge capacity reached the target discharge capacity of 560 mA·h/g. The aggregate duration required to complete this pre-lithiation was around 29 hours.

### Example 2: Controlled Discharge Sequence for Pre-Lithiation

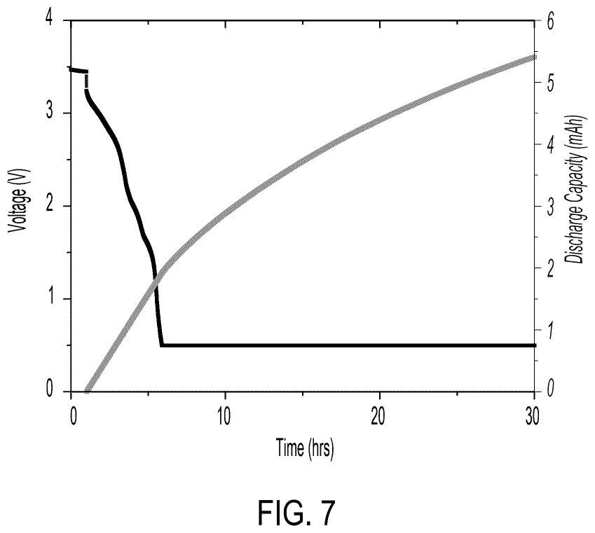

A coin cell is fabricated according to FIG. 1, and then tested for pre-lithiation of V₂O₅ electrode using a controlled discharge sequence employing a constant current, constant voltage (CCCV) discharge strategy. The results are shown in FIG. 7.

In this Example 2, the coin cell undergoes discharge at a rate of 0.2 C until the voltage level attains 0.5 V. Subsequently, the cell is maintained at a constant voltage of 0.5 V while continuing the discharge process until the discharge capacity aligns with the specified target of 560 mA·h/g. The cumulative time required to complete this pre-lithiation procedure was around 30 hours.

Example 3: Pre-Lithiation of Li-Ion Pouch Cell Using Three Electrodes.

This example uses a pouch-cell configuration with three electrodes, as depicted in FIG. 5. The first electrode is LiNi_{0.8}Mn_{0.1}Co_{0.1}O₂ cathode, the second electrode is V₂O₅ anode, and the third electrode is Li.

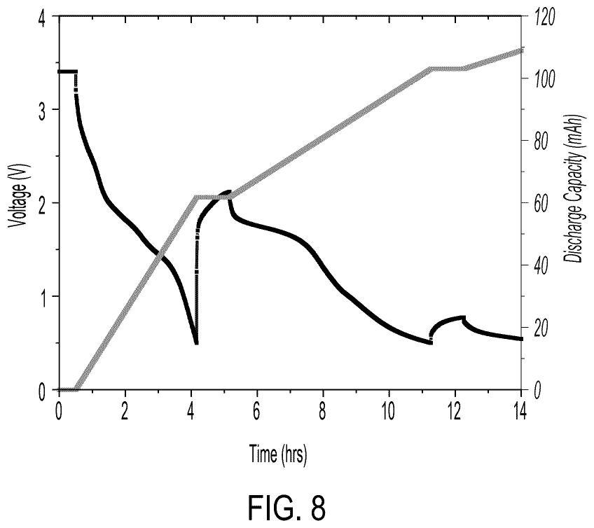

The three-electrode pouch cell is then tested for pre-lithiation as shown in FIG. 8, employing a pre-lithiation phase partitioned into multiple sequential stages. Current is applied to the V₂O₅ electrode and Li electrode for prelithiation. The initial discharge rate applied is at 0.5 C, with a cut-off voltage set at 0.5 V. Subsequently, discharge current rates of 0.2 C, 0.1 C, and 0.05 C are consecutively employed to facilitate the discharge of the pouch cell with the same cut-off voltage of 0.5 V. Eventually, the pouch cell undergoes discharge at a rate of 0.05 C, maintaining the 0.5 V cut-off voltage, until the discharge capacity attains the desired value of 560 mA·h/g. The cumulative time required to complete the pre-lithiation process is approximately 15 hours.

### Example 4: Performance Testing of Pre-Lithiated Li-Ion Pouch Cell

The pre-lithiated pouch cell of Example 3 (after the culmination of the pre-lithiation process) is subjected to comprehensive performance testing.

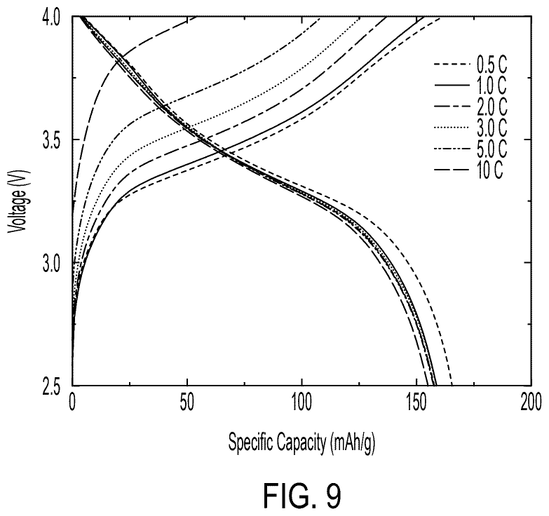

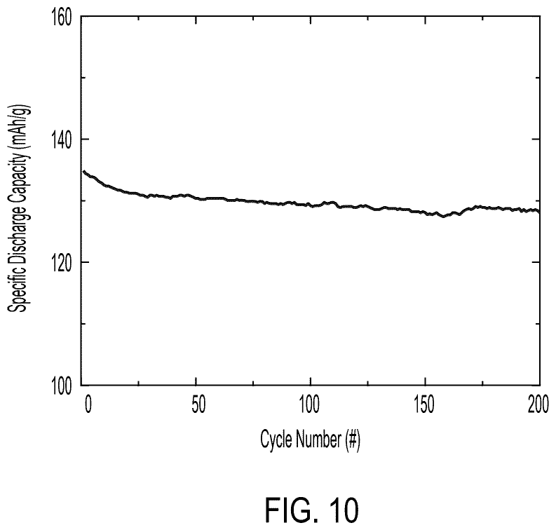

Diverse charging current rates, including 0.5 C, 1.0 C, 2.0 C, 3.0 C, 5.0 C, and 10.0 C, were systematically employed to charge the pouch cell, which was subsequently discharged at a rate of 0.2 C. The results are shown in FIGS. 9, 10, and 11.

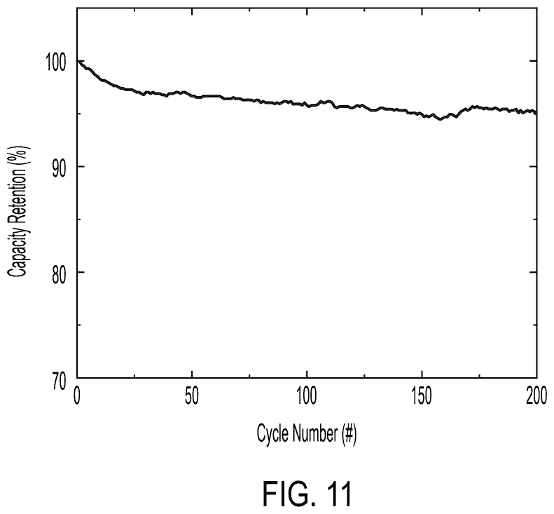

According to FIG. 9, the pouch cell showed a good capability at high current rates. Following the rate evaluation, a cycling testing was performed. The pouch cell showed a cathode specific discharge capacity of about 130 mA·h/g after 200 cycles with a capacity retention of about 95% (FIG. 11).

### Example 5: Synthesis of Pre-Lithiated Electrode Material Using a Liquid Lithium-Ion Conductor

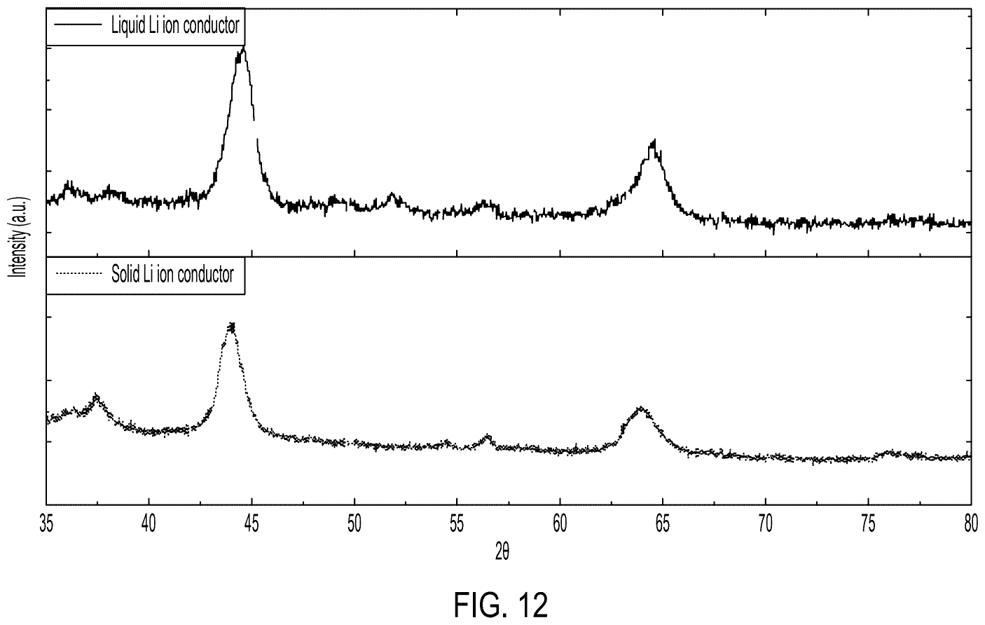

V₂O₅ powder, Li chip as Li-containing layer, LiPF₆ in dimethyl carbonate solvent as liquid Li-ion conductor, and carbon black as electron/ion conductor are placed in a ball mill jar with ZrO₂ balls. They are ball milled at 500 rpm for 3 hours. The powders are filtered and washed by DMC, and fully dried to achieve Li₃V₂O₅. XRD analysis in FIG. 12 (upper panel) shows pure disordered rocksalt structure in the Fm3̅m space group.

### Example 6: Synthesis of Pre-Lithiated Electrode Material Using Solid Lithium-Ion Conductor

V₂O₅ powder, Li chip as Li-containing layer, and carbon black as electron/ion conductor are placed in a ball mill jar with ZrO₂ balls. They are ball milled at 500 rpm for 3 hours. The achieved powders are Li₃V₂O₅. XRD analysis in FIG. 12 (lower panel) shows pure disordered rocksalt structure in the Fm3̅m space group.

### Example 7: Synthesis of Pre-Lithiated Electrode Material Using Solid Lithium-Ion Conductor at Different Scales

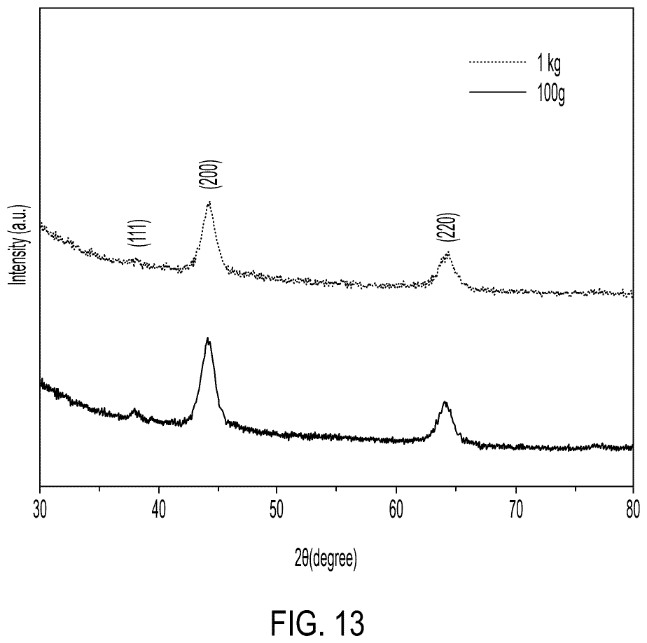

V₂O₅ powder, a Li chip as a Li-containing layer, and carbon black as an electron/ion conductor are placed in a rolling mill jar with ZrO₂ balls. The mixture is rolling-jar milled at 150 rpm for over 12 hours. One batch is 100 g total, while another batch is 1 kg total. The reactions using either batch size achieved powders that are Li₃V₂O₅. XRD analysis in FIG. 13 shows pure disordered rocksalt structure in the Fm3̅m space group.

What is claimed is:

1. A method of pre-lithiating an electrode material for a lithium-ion battery, said method comprising:
(a) providing an electrode precursor material having an initial degree of lithiation, wherein said electrode precursor material is in powder form;
(b) providing a solid lithium-containing material;
(c) blending and mechanically agitating said electrode precursor material and said solid lithium-containing material;
(d) simultaneously with step (c), or sequentially after step (c), reacting lithium, initially contained in said solid lithium-containing material, with said electrode precursor material, using effective lithiation reaction conditions, thereby generating a lithiated electrode material; and
(e) recovering said lithiated electrode material, wherein step (e) optionally utilizes washing, filtering or other separation, drying, thermal treatment at a temperature up to about 300° C., or a combination thereof.

2. The method of claim 1, wherein said lithiated electrode material is a lithiated anode material.

3. The method of claim 1, wherein said lithiated anode material is selected from the group consisting of lithiated vanadium oxide, lithiated silicon, lithiated silicon oxide, lithiated silicon/C, lithiated graphite, lithiated carbon, lithiated hard carbon, lithiated soft carbon, lithiated aluminum, lithiated magnesium, lithiated zinc, lithiated tin, lithiated tin oxide, lithiated phosphorus, and combinations thereof.

4. The method of claim 2, wherein said electrode precursor material contains vanadium oxide and/or lithium vanadium oxide, wherein said lithiated anode material contains lithium vanadium oxide LiₐV_{b}O_{c}, and wherein a=1-10, b=1-3, c=1-9, and a, b, and c are selected to charge-balance said LiₐV_{b}O_{c}.

5. The method of claim 4, wherein at least some of said LiₐV_{b}O_{c} has a disordered rocksalt structure in the Fm3̅m space group.

6. The method of claim 1, wherein said lithiated electrode material is a lithiated cathode material.

7. The method of claim 6, wherein said lithiated cathode material is selected from the group consisting of lithiated sulfur, lithiated sulfurized polyacrylonitrile, lithiated ferric fluoride, lithiated metal fluoride, lithiated metal sulfide, lithiated lithium nickel manganese cobalt oxide (LiNiₓCo_{y}Mn_{z}O₂ (x+y+z=1)), lithiated lithium nickel manganese oxide (LiNiₓMn_{z}O₂ (x+z=1)), lithiated lithium nickel cobalt oxide (LiNiₓCo_{y}O₂ (x+y=1)), lithiated lithium nickel cobalt aluminum oxide (LiNiₓCo_{y}Al_{z}O₂ (x+y+z=1)), lithiated lithium cobalt oxide (LiCoO₂), lithiated lithium nickel manganese spinel oxide (LiMnₓNi_{y}O₄ (x+y=2)), lithiated lithium manganese spinel oxide (LiMn₂O₄), lithiated lithium iron phosphate (LiFePO₄), lithiated lithium iron manganese phosphate (LiFeₓMn_{y}PO₄ (x+y=1)), lithiated lithium manganese spinel oxide (Li₂MnO₃), lithiated lithium-rich manganese-rich layered oxide (aLiNiₓCo_{y}Mn_{z}O₂·(1−a)Li₂MnO₃ (0<a<1 and x+y+z=1)), LiF, Li₂S, Li₂O, Li₂O₂, and combinations thereof.

8. The method of claim 1, wherein said initial degree of lithiation is 0 prior to step (d).

9. The method of claim 1, wherein said initial degree of lithiation is greater than 0 prior to step (d).

10. The method of claim 1, wherein said electrode precursor material is doped with one or more dopants M, and wherein M is selected from the group consisting of Na, K, Be, Mg, Ca, Zn, Fe, Co, Ni, Cu, Ag, Sc, B, Y, Al, La, Si, Ge, Sn, Ti, Zr, Mn, P, Nb, Ta, Cr, Mo, W, Se, N, S, F, Cl, Br, I, and combinations thereof.

11. The method of claim 1, wherein said lithium-containing layer is in the form of a foil, an ingot, a powder, a wire, or a combination thereof.

12. The method of claim 1, wherein said solid lithium-containing material is pure lithium.

13. The method of claim 1, wherein said solid lithium-containing material is a lithium compound.

14. The method of claim 13, wherein said lithium compound is a lithium-ion conductor.

15. The method of claim 14, wherein said lithium-ion conductor is selected from the group consisting of oxides, sulfides, phosphates, argyrodites, β-aluminas, LISICON, garnets, NASICON, perovskites, antiperovskites, lithium nitrides, lithium hydrides, lithium phosphidotrielates and phosphidotetrelates, lithium metal halides, LIPON, lithium thiophosphates, LiAlH₄, LiBH₄, and combinations thereof.

16. The method of claim 1, wherein said solid lithium-containing material is a powder with an average particle size selected from about 0.01 microns to about 20 microns.

17. The method of claim 1, wherein said electrode precursor material has an average particle size selected from about 0.05 microns to about 20 microns.

18. The method of claim 1, wherein after step (c), the mechanically agitated material consisting of said electrode precursor material and said solid lithium-containing material has an average particle size selected from about 0.05 microns to about 20 microns.

19. The method of claim 1, wherein step (c) employs ball milling, bead milling, roll jar milling, or a combination thereof.

20. The method of claim 1, wherein said effective lithiation reaction conditions include a lithiation temperature selected from about −40° C. to about 200° C.

21. The method of claim 1, wherein said effective lithiation reaction conditions include a reaction atmosphere of an inert gas, wherein said inert gas is optionally Ar, He, and/or N₂.

22. The method of claim 1, wherein said effective lithiation reaction conditions include a reaction atmosphere of dry air.

23. The method of claim 1, wherein said effective lithiation reaction conditions include a lithiation reaction time selected from about 0.1 hr to about 168 hr.

24. The method of claim 1, wherein said effective lithiation reaction conditions include a lithiation pressure selected from about 0.01 MPa to about 10 MPa.

25. The method of claim 1, wherein lithium reaction with said electrode precursor material in step (d) is promoted by the presence of an electron conductor, an ion conductor, an electron-ion conductor, or a combination thereof, disposed on, or within, said electrode precursor material.

26. The method of claim 1, wherein lithium reaction with said electrode precursor material in step (d) is promoted by the presence of an electron conductor, an ion conductor, an electron-ion conductor, or a combination thereof, disposed on, or within, said solid lithium-containing material.

27. The method of claim 25, wherein said electron-ion conductor contains carbon.

28. The method of claim 27, wherein said carbon is selected from the group consisting of amorphous carbon, carbon nanotubes, carbon black, vapor-growth carbon fiber, ultra-fine carbon, graphene, graphite, hard carbon, soft carbon, sp carbon, sp² carbon, sp³ carbon, and combinations thereof.
